(19) United States
(12) Patent Application Publication
(10) Pub. No.: US 2024/0370448 A1
(43) Pub. Date: Nov. 7, 2024

(54) System and Methods for Extracting Statistical Information From Documents

(71) Applicant: System Inc., New York, NY (US)

(72) Inventors: Thet Naing, New York City, NY (US); Alissa Wang, New York City, NY (US); Sugreev Chawla, New York City, NY (US); Mehdi Jamei, New York City, NY (US); Adam Bly, New York City, NY (US)

(21) Appl. No.: 18/643,248

(22) Filed: Apr. 23, 2024

Related U.S. Application Data
(60) Provisional application No. 63/463,374, filed on May 2, 2023.

(51) Int. Cl. G06F 16/2458; G06F 16/248; G06F 16/901; G06F 16/93

(52) U.S. Cl. CPC G06F 16/2462; G06F 16/248; G06F 16/9024; G06F 16/93

(57) ABSTRACT

Embodiments of the disclosure provide an end-to-end system for extracting statistical relationships from scientific literature using a variety of machine learning (ML) and statistical models, including generative large language models (LLMs). The system is designed to identify and extract two types of statistical relationships: “generic” or effect size relationships and “paired” or group comparison relationships.

### CROSS REFERENCE TO RELATED APPLICATION

This application claims the benefit of U.S. Provisional Application No. 63/463,374, entitled “System and Methods for Extracting Statistical Information from Documents,” filed May 2, 2023, the disclosure of which is incorporated, in its entirety (including the Appendix), by this reference.

References to “System” in the context of an architecture or to the System architecture or platform herein refer to the architecture, platform, and processes for performing statistical search and other forms of data organization described in U.S. patent application Ser. No. 16/421,249, entitled “Systems and Methods for Organizing and Finding Data”, filed May 23, 2019, now U.S. Pat. No. 11,354,587 issued Jun. 7, 2022, which claims priority from U.S. Provisional Patent Application Ser. No. 62/799,981, entitled “Systems and Methods for Organizing and Finding Data”, filed Feb. 1, 2019, the entire contents of which (and of any related applications claiming priority to one or more of those applications) are incorporated by reference in their entirety into this application.

### BACKGROUND

Information and relationships contained in documents describing studies, investigations, and scientific work can be very valuable to those who are interested in the same or related topics. However, identifying and extracting statistical relationships from a set of sources can be challenging, at least in part because reviewing and processing a large number of such documents is time-consuming and computationally expensive. Embodiments of the systems and methods disclosed herein are directed to solving these and related problems individually and collectively.

### SUMMARY

The terms “invention,” “the invention,” “this invention,” “the present invention,” “the present disclosure,” or “the disclosure” as used herein refer broadly to the subject matter disclosed and/or described in this specification, the drawings or figures, and to the claims. Statements containing these terms do not limit the subject matter disclosed or described, or the meaning or scope of the claims. Embodiments of this disclosure are defined by the claims and not by this summary. This summary is an overview of various aspects of the disclosure and introduces some of the concepts that are further described in the Detailed Description section. This summary is not intended to identify key, essential, or required features of the claimed subject matter, nor to be used in isolation to determine the scope of the claimed subject matter. The subject matter should be understood by reference to appropriate portions of the entire specification, to any or all figures or drawings, and to each claim.

Embodiments of the disclosure relate to the field of machine learning (ML) and natural language processing (NLP), and specifically, provide an end-to-end system or platform for extracting statistical relationships from scientific literature using one or more machine learning and/or statistical models, including generative large language models (LLMs).

In the context of the disclosure and as used herein, a “statistical relationship” is a relationship established between two variables using an effect size measure/metric or a significance test (i.e., a valid and accepted methodology for establishing such a relationship). In one embodiment, the disclosed and/or described system operates to identify and extract two types of statistical relationships from a source or sources: (1) “generic” or “effect size” relationships and (2) “paired” or “group comparison” relationships.

In one embodiment, the disclosure is directed to a method for extracting statistical relationships from scientific literature or another source. The method identifies and extracts two types of statistical relationships: (1) “effect size” relationships and (2) “group comparison” relationships. An embodiment of the disclosure in the form of a method may include one or more of the following steps, stages, elements, components, functions, operations, or processes:
Access and initiate processing of published abstracts from a source of documents;
   In one non-limiting example, this is a PubMed server representing publications from the National Institute for Health or NIH (found at https://pubmed.ncbi.nlm.nih.gov/);
Perform sentence splitting on each of a set of the accessed abstracts;
Perform a pattern-based and/or model-based tagging (labeling) process for each of the sentences to isolate relevant sections of text;
   Where non-limiting examples of such sections of text may include one or more of text describing the experimental methods (i.e. study inclusion/exclusion criteria, statistical methods used) and results/findings of the study;
This is followed by a statistical relationship extraction process;
   In one embodiment, the relationship extraction process (referred to as REx herein) comprises one processing flow:
      The REx process prompts an LLM to identify and extract both “effect size” and “group comparison” relationships from an abstract and place the output into a predefined JSON object that reflects the structure defined herein (a non-limiting example of which is provided as part of this specification);
      For each extracted relationship (i.e., effect size or group comparison), the LLM model is prompted to provide: (1) an excerpt of text from which it is extracting the relationship and (2) a rationale for the extraction. The inclusion of a rationale is an application of Chain of Thought (CoT) prompting, aimed at increasing the LLM's reasoning capabilities as part of ongoing training of the LLM;
   In one embodiment, the relationship extraction process comprises two separate processing flows (referred to as GREx and PREx herein), which instead of execution of the REx flow, individually extract either effect size (GREx) or group comparison (PREx) relationships:
      In one embodiment, the disclosed and/or described PREx process prompts an LLM to extract “paired” or comparison group relationships from a source of interest and place that information into a predefined string representation of a JSON object;
         In one embodiment, a sentence splitting and model-based tagging or labeling process may be applied prior to the paired relationship extraction processing;
      This is followed by use of a generic or effect size relationship extraction process (referred to as GREx herein). In one embodiment, the disclosed and/or described GREx process prompts an LLM to extract “generic” relationships from a source of interest and place that information into a predefined string representation of a JSON object;
         In one embodiment, a pattern-based tagging or labeling process may be applied prior to the generic relationship extraction processing;
The outputs of the relationship extraction (REx) process or processes (PREx and GREx) are input to a structured relationship process flow. In one non-limiting example, this structured relationship process flow may operate as follows;
   Converting the extracted LLM outputs into a structured relationship allows processing each relationship based on its components. This may include checking that the outputs conform to the desired definition(s) of a relationship. This allows the filtering out of bad data and false positives, and the validation of the relationships by performing data validation on each component;
   If the two-flow relationship extraction process was used to extract effect size relationships (GREx) in a separate processing flow from group comparison relationships (PREx), then if needed, parse/load raw predictions, which are returned directly from the LLM as string representations of JSON (JavaScript Object Notation) objects, into “valid” JSON objects. A relationship that cannot be properly parsed into a valid JSON object may be discarded to reduce the risk of relying on inaccurate extractions;
   Validate elements of the extracted relationships (from either the REx flow or from the GREx and PREx flows) to ensure that they meet acceptable requirements, both as individual components as well as in relation to one another. This is done to filter out relationships that may be parsed out incorrectly or incompletely. In one non-limiting example, this validation process may include one or more of:
      Checking that confidence interval bounds (when found) are valid. That is, CI lower (confidence interval lower bound) must be lower and unequal to CI upper, and the statistic value must be between the CI bounds;
      Check that p value, when found, falls within the interval (0, 1) (and not including 0 or 1);
   In the case of “group comparison” relationships, the relationships may be transformed into a structured relationship by the following:
      assigning the relationship to a default statistic type of mean difference;
      consolidating the names of the two independent variable groups/times into one variable_1 name;
         In one embodiment, the effect size relationships are already in the desired format (as shown in FIG. 1(e). The group comparison associations are transformed into this format, so that all relationships can be represented in a single format;
Variables obtained from the output of the structured relationships process flow are then “cleaned” (if needed);
   In one non-limiting example, this may comprise one or more of:
      Normalization of Unicode text to canonical ASCII equivalents, to allow for greater compatibility with downstream applications (e.g., display on web pages);
      Spelling out abbreviations used in a variable as defined in the source text. As an example: extracted variable ART from the text, which defines the abbreviation as Antiretroviral therapy (ART). The variable is corrected to Antiretroviral therapy, making the variable clearer and more informative than its original extracted form;
A semantic grounding process is then performed to more effectively clarify and/or expand the variable names or identifiers;
   As a non-limiting example, this may comprise accessing one or more comprehensive ontologies (and/or a relevant dictionary or thesaurus) to identify a similar or a generalized form of a term or concept;
After completion of the preceding steps or stages, the resulting variables, and relationships (effect size and group comparison) and associated statistical information is stored in a database for later access and evaluation;
   Such access and evaluation may include one or more of the uses disclosed and/or described in other pending and issued applications assigned to the present assignee;
      Such as, but not limited to U.S. patent application Ser. No. 17/983,180, which is a Continuation-in-Part of U.S. patent application Ser. No. 17/736,897, which is a Continuation of U.S. patent application Ser. No. 16/421,249 filed May 23, 2019, now U.S. Pat. No. 11,354,587 issued Jun. 7, 2022, which claims the benefit of priority from 62/799,981 filed Feb. 1, 2019, entitled “Systems and Methods for Organizing and Finding Data”;
   As a non-limiting example, one use case is to improve the accuracy and utility of search results provided in response to a user query by identifying results that represent content that includes effect size relations and/or group size relationships, as such sources may be expected to be more likely to be relevant to the query or provide support for the result of a search;
      In the context of the “System” architecture, the disclosed and/or described processing flow may be used to extract information and data that is then used to populate a knowledge or feature graph which may be searched by a user to identify potentially useful datasets and information.

In one embodiment, the disclosure is directed to a system for extracting statistical relationships from scientific or other literature. The system may include a set of computer-executable instructions and an electronic processor or co-processors. When executed by the processor or co-processors, the instructions cause the processor or co-processors (or a device of which they are part) to perform a set of operations that implement an embodiment of the disclosed and/or described method or methods.

In one embodiment, the disclosure is directed to a set of computer-executable instructions contained in (or on) one or more non-transitory computer-readable media, wherein when the set of instructions are executed by an electronic processor or co-processors, the processor or co-processors (or a device of which they are part) perform a set of operations that implement an embodiment of the disclosed and/or described method or methods.

In some embodiments, the systems and methods disclosed and/or described herein may provide services through a SaaS or multi-tenant platform. The platform provides access to multiple entities, each with a separate account and associated data storage. Each account may correspond to a user, set of users, an entity (such as the assignee) providing a knowledge or feature graph to enable a user to identify datasets for training a model or use in generating a metric of interest, a set or source of documents, or an organization that is identifying relevant sources and accessing and navigating a knowledge or feature graph, for example. An account or user may desire to use an embodiment to search for scientific research/findings, synthesize or summarize research in a particular area of interest, or perform a literature review, as non-limiting examples. Each account may access one or more services, a set of which are instantiated in their account, and which implement one or more of the methods or functions disclosed and/or described herein.

Other objects and advantages of the systems, apparatuses, and methods disclosed and/or described herein may be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, embodiments of the disclosure are not limited to the exemplary or specific forms described. Rather, the present disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a flowchart or flow diagram illustrating a set of steps, stages, functions, operations, or processes that may be implemented in embodiment of the disclosed and/or described system and methods in which a single process flow is used as part of the statistical relationship extraction process;

FIG. 1(b) is a flowchart or flow diagram illustrating a set of steps, stages, functions, operations, or processes that may be implemented in embodiment of the disclosed and/or described system and methods in which two process flows are used as part of the statistical relationship extraction process;

FIG. 1(c) is a block diagram illustrating a set of elements, components, functions, processes, or operations that may be part of a system architecture or data processing pipeline in which an embodiment of the disclosed and/or described system and methods may be implemented for a single process flow used as part of the statistical relationship extraction process;

FIG. 1(d) is a block diagram illustrating a set of elements, components, functions, processes, or operations that may be part of a system architecture or data processing pipeline in which an embodiment of the disclosed and/or described system and methods may be implemented for the use of two process flows as part of the statistical relationship extraction process;

FIG. 1(e) is a block diagram illustrating a data structure that may be used to represent statistical relationships extracted from documents, as part of an implementation of an embodiment of the disclosed and/or described system and methods;

FIG. 2(a) is a block diagram illustrating a set of elements, components, functions, processes, or operations that may be implemented to generate tags or labels for text extracted from a corpus of documents as part of implementing an embodiment of the disclosed and/or described system and methods;

FIG. 2(b) is a diagram illustrating a process flow or data processing pipeline for extracting statistical relationships from a corpus of documents in a single process flow (REx) as part of implementing an embodiment of the disclosed and/or described system and methods;

FIG. 2(c) is a diagram illustrating a process flow or data processing pipeline (GREx) for extracting effect size (generic) statistical relationships from a corpus of documents as part of implementing an embodiment of the disclosed and/or described system and methods;

FIG. 2(d) is a diagram illustrating a process flow or data processing pipeline (PREx) for extracting group comparison (paired) statistical relationships from a corpus of documents as part of implementing an embodiment of the disclosed and/or described system and methods;

FIG. 2(e) is a diagram illustrating a process flow or data processing pipeline for “grounding” identified variables using one or more ontologies as part of implementing an embodiment of the disclosed and/or described system and methods;

FIG. 2(f) is a diagram illustrating a use of the disclosed and/or described statistical relationship extraction process flow(s) as part of populating a feature or knowledge graph of the type enabled by the assignee, and then using that feature or knowledge graph to execute a search to identify concepts and related data or metadata for that search;

FIG. 2(g) is a diagram illustrating elements, components, or processes that may be present in or executed by one or more of a computing device, server, platform, or system configured to implement a method, process, function, or operation in accordance with some embodiments of the disclosed and/or described system and methods; and

FIGS. 3-5 are diagrams illustrating an architecture for a multi-tenant or SaaS platform that may be used in implementing an embodiment of the disclosed and/or described system and methods.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among others, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, co-processor, microprocessor, CPU, GPU, TPU, QPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the disclosure may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, in some embodiments, the systems and methods disclosed and/or described herein may provide services through a SaaS or multi-tenant platform. The platform provides access to multiple entities, each with a separate account and associated data storage. Each account may correspond to a user, set of users, an entity (such as the assignee) providing a knowledge graph to enable a user to identify datasets for training a model or use in generating a metric of interest, a set or source of documents, or an organization that is identifying relevant sources and accessing and navigating a knowledge graph, for example. Each account may access one or more services, a set of which are instantiated in their account, and which implement one or more of the methods or functions disclosed and/or described herein.

As mentioned, embodiments relate to the field of machine learning (ML) and natural language processing (NLP), and specifically, provide an end-to-end system or platform for extracting statistical relationships from scientific literature using one or more machine learning and/or statistical models, including generative large language models (LLMs). The extracted relationships may be used to populate a knowledge graph or other form of data structure that can be searched to identify datasets and information that are more likely to be relevant to a user's query or research.

In the context of the disclosure and as used herein, a “statistical relationship” is a relationship established between two variables using an effect size measure/metric or a significance test (i.e., a valid and accepted methodology for establishing such a relationship). In one embodiment, the disclosed and/or described system operates to identify and extract two types of statistical relationships from a source or sources: (1) “generic” or “effect size” relationships and (2) “paired” or “group comparison” relationships. The components of such a statistical relationship typically include:
two variables;
a statistic type (an effect size measure, such as (as non-limiting examples) odds ratio or Pearson correlation;
a statistic value (the value of that effect size);
a confidence interval (if present); and
a p-value (if present).

In the context of the disclosure and as used herein, an “effect size” or “generic” relationship is one that is explicitly measured by an effect size and found in the text of a reference or literature. The relationship is established by explicit evidence of an effect size measure by investigators and described in a reference or literature.

In the context of the disclosure and as used herein, a “group comparison” or “paired” relationship, is not explicitly measured by an effect size in the literature or other record of an investigation. Instead, the literature or record provides a comparison between two values accompanied by a measure of statistical significance. These pairs of values may refer to different groups, different trials, or different time periods, as non-limiting examples. For these relationships, the disclosed approach may be used to calculate an effect size based on the paired values and the accompanying significance value(s) (for example by use of the “mean difference” default statistic type disclosed herein).

One or more embodiments may also (or instead) extract study metadata and characteristics such as sample size, population characteristics (e.g., age, gender, sex, disease conditions, or co-morbidities), and/or control variables using a similar approach to that disclosed and/or described herein.

As a non-limiting example, in one study reported in a source document, 100 women ages 25-40 with a history of diabetes mellitus were randomly assigned to receive 100 mg of Drug X or a saline solution placebo. This scenario would result in the following metadata describing the study being extracted from the study or reference document(s):
Sample size: 100;
Study population:
   Sex: Female;
   Age: 25-40;
   Disease/condition: diabetes mellitus;
   Treatment: Drug X, 100 mg;
   Control variables: Saline placebo, 100 mg.

The flexibility in working with both effect size (generic) and group comparison (paired) relationships allows the disclosed and/or described system and methods to extract many (if not all) statistical relationships as they are presented in scientific and other literature.

In some embodiments, the disclosed and/or described system (or platform, method, apparatus, or device) identifies candidate documents containing potential statistical relationships using a combination of rules and machine learning models (such as the disclosed tagging process flow(s)). These documents are then classified (in one embodiment, also as part of the tagging process flow(s)) to “predict” the likelihood of containing either effect size and/or group comparison relationships using patterns and/or supervised transformer models.

The extraction of relationships from the documents is performed using large language models (LLMs), which are prompted and guided by examples specifically designed for the corresponding type of relationship (i.e., effect size or group comparison). The raw data representing the extracted relationships are subsequently parsed into valid JSON objects (if not performed by the extraction process itself).

To ensure the extracted relationships adhere to a predefined definition or format, embodiments “clean” and validate individual components of the extracted relationships. The variables from the relationships are then grounded to concepts from an ontology, such as (as a non-limiting example) the Unified Medical Language System (UMLS), which combines terminology from a wide variety of scientific ontologies and knowledge bases, including Medical Subject Headings (MeSH), ICD-10, and SNOMED CT. In this example, the ontologies were chosen for their comprehensiveness and interoperability with one another and with non-specialized ontologies such as Wikidata. However, embodiments are flexible enough to incorporate grounding using one or more other relevant ontologies.

The resulting relationships, along with their respective variables and UMLS concepts (which in some cases may provide an alternative or generalized form of a term, variable, label, or concept), can be utilized to generate meta-analyses, visualize research networks, and facilitate other applications in the scientific or technical domains. Embodiments offer a robust and efficient solution for extracting valuable insights from scientific literature, thereby enhancing the understanding and application of statistical relationships in research and practice.

For example, the resulting relationships can be loaded into a relational or graph database for applications that allow for one or more of:
Performing a semantic search based on components such as variable names (e.g., search for relationships involving metabolic syndrome), statistic types (e.g., search for odds ratios), statistic values (e.g., search for odds ratios >1.0), or the significance of the relationship at a particular confidence level (e.g., filter for relationships significant at 95% confidence level);
Performing a meta-analysis in which findings from a particular area of study (e.g., all relationships involving metabolic syndrome as a determinant) are filtered and statistical analyses are performed to calculate the consensus (or lack thereof) of relationships between variables based on the statistical findings.

A non-limiting and example embodiment of an implementation of one or more of the disclosed and/or described data processing approaches is presented in the following. In this example, PubMed (which contains biomedical publications and is found at https://pubmed.ncbi.nlm.nih.gov/) is used as a primary source of data to identify statistical relationships in studies and investigations. PubMed's public FTP server provides a comprehensive collection of XML files containing abstracts and other metadata related to a large selection of scientific publications.

In some embodiments, a primary focus or goal is to identify the key findings presented in an abstract and the results/conclusions section(s) found in the text of a publication. These sections are expected to be valuable as they typically summarize the most significant outcomes and insights derived from the research described in the publication. By concentrating on these portions of a document, embodiments can efficiently extract one or more statistical relationships that underpin the scientific findings described in the publication. This approach enables an embodiment to effectively identify and analyze what is expected to be the most relevant data, thereby streamlining the extraction process and improving the accuracy and reliability of the results.

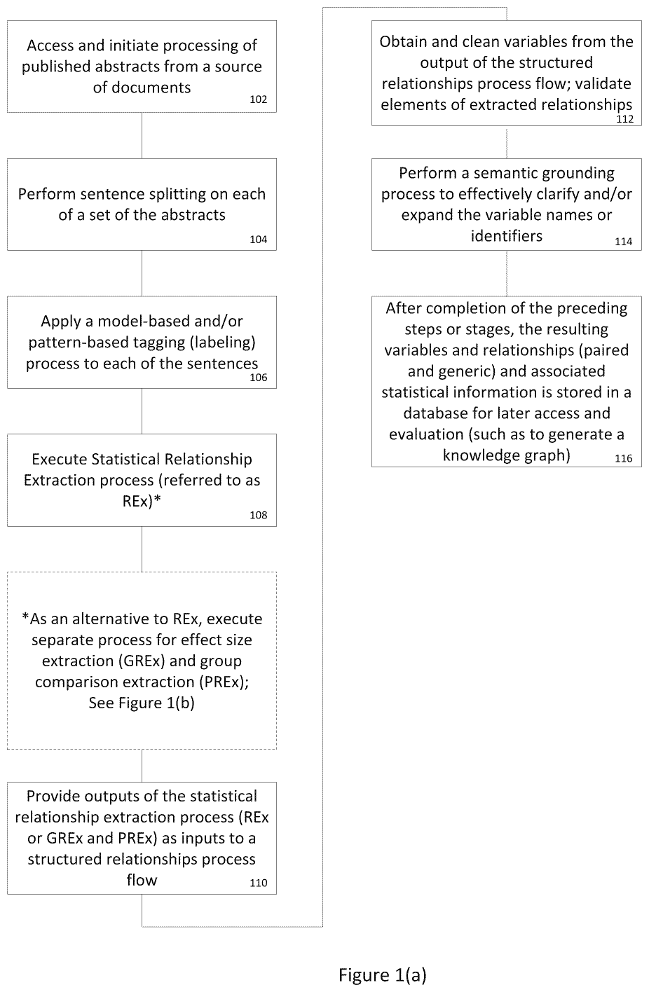

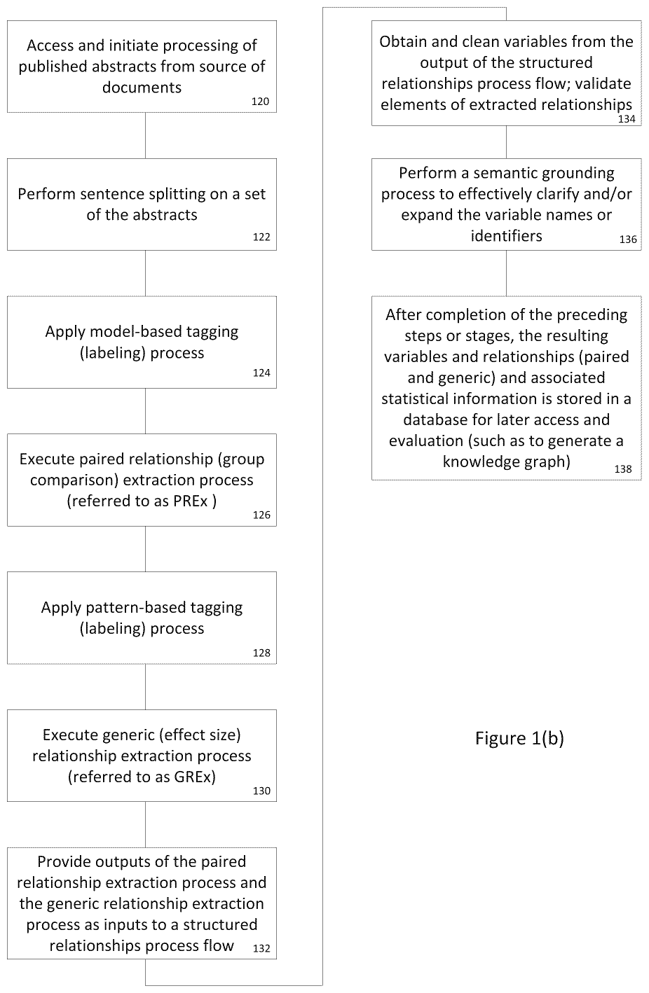

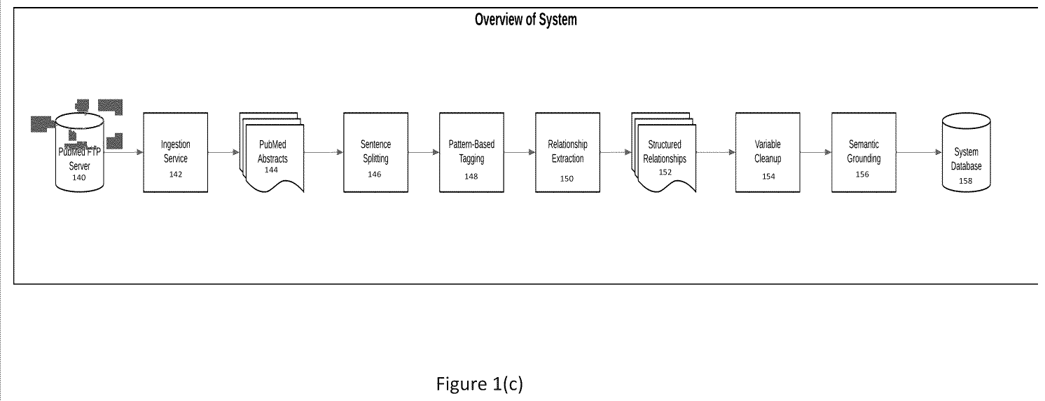

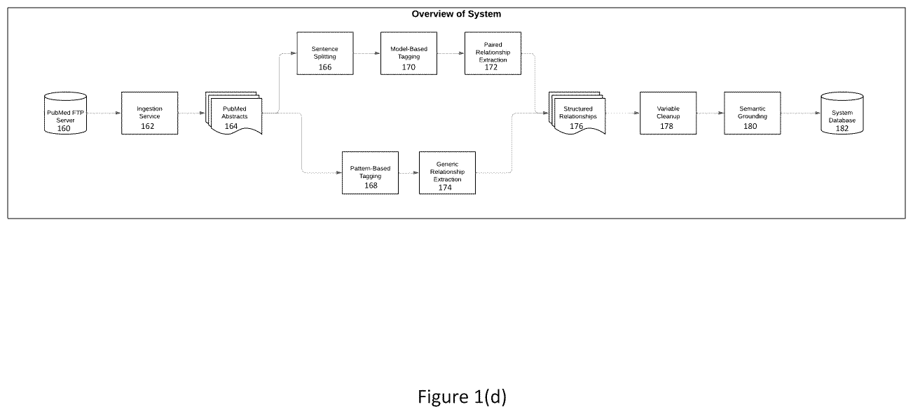

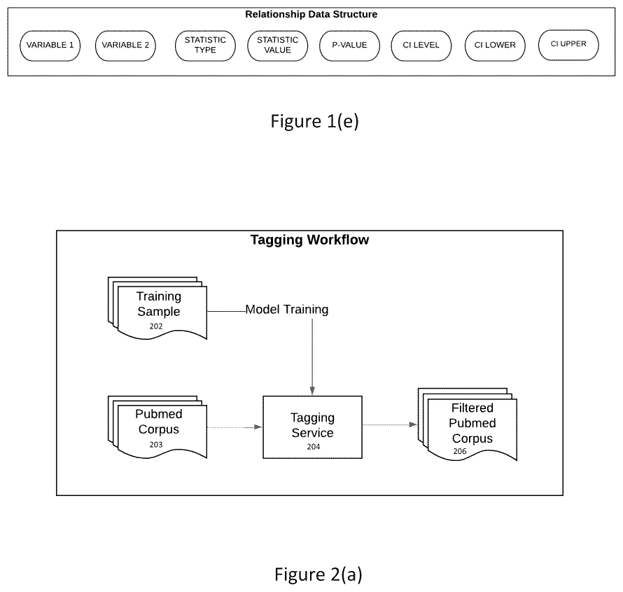

FIG. 1(a) is a flowchart or flow diagram illustrating a set of steps, stages, functions, operations, or processes that may be implemented in embodiment of the disclosed and/or described system and methods in which a single process flow is used as part of the statistical relationship extraction process. This may be preferable to implementing the extraction process flow in two separate flows or pipelines (one for effect size and one for group comparison relationships) for one of several reasons:
Combining both tasks into one can help prevent situations in which one type of relationship is mistaken for another (e.g., an LLM trying to extract an effect size relationship rather than extracting a group comparison relationship);
Use of a single processing flow simplifies the implementation and data flow; and
Use of a single processing flow reduces the cost and overhead of the LLM(s) used in the process.

As shown in FIG. 1(a), in the example embodiment, the processing flow may include the following steps, stages, operations, or functions:
Access and initiate processing of published abstracts from a source of documents (as suggested by step or stage 102);
   In one non-limiting example, this is a PubMed server representing publications from the National Institute for Health or NIH (found at https://pubmed.ncbi.nlm.nih.gov/);
   In some embodiments, other portions of an article may be accessed and evaluated for potential relevance (such as results, conclusions, or other potentially relevant sections);
Perform sentence splitting on each of a set of the accessed abstracts (as suggested by step or stage 104);
   This can be performed with a number of techniques including rule-based sentence boundary disambiguation (SBD), or by using a transformer model trained or fine-tuned for this specific task;
Perform a pattern-based and/or model-based tagging (labeling) process for each of the sentences to isolate relevant sections of text (as suggested by step or stage 106);
   In particular, section(s) of text describing the experimental methods (i.e., study inclusion/exclusion criteria, statistical methods used) and results/findings of the study;
This is followed by a relationship extraction process (as suggested by step or stage 108);
   In one embodiment, the relationship extraction process (referred to as REx herein) comprises one processing flow:
      The REx process prompts an LLM to identify and extract both “effect size” and “group comparison” relationships from an abstract and place the output into a predefined JSON object that reflects the structure defined herein;
         As a non-limiting example, in one embodiment, this JSON object may be defined as follows:

```
{
  “type”: “object”,
  “properties”: {
    “group_comparison_associations”: {
      “type”: “array”,
      “items”: {
        “type”; “object”,
        “properties”: {
          “text”: {
            “type”: “string”,
            “description”: “The text of the association.”,
          },
          “rationale”: {
            “type”: “string”,
            “description”: “The rationale for identifying and extracting this association.”,
          },
          “independent_variable_group_1”: {
            “type”: “string”,
            “description”: “The independent variable/variable of interest, treatment group.”,
          },
          “independent_variable_group_2”: {
            “type”: “string”,
            “description”: “The independent variable/variable of interest, control/reference
group.”,
          },
          “dependent_variable”: {
            “type”: “string”,
            “description”: “The dependent variable/outcome variable.”,
          },
          “independent_variable_group_1_value”: {
            “type”: “number”,
            “description”: “The group mean/median/proportion of the treatment group.”,
          },
          “independent_variable_group_2_value”: {
            “type”: “number”,
            “description”: “The group mean/median/proportion of the control/reference
group.”,
          },
          “p_value_equality”: {
            “type”: “string”,
            “enum”: [“>”, “<”, “=”, “>=”, “<=”],
            “description”: “The equality used to report the value of the p-value (e.g., <, =, <=,
etc.), if reported.”,
          },
          “p_value”: {
            “type”: “number”,
            “description”: “The value of the p-value, if reported.”,
          },
        },
        “required”: [
          “text”,
          “rationale”,
          “independent_variable_group_1”,
          “independent_variable_group_2”,
          “dependent_variable”,
          “independent_variable_group_1_value”,
          “independent_variable_group_2_value”,
          “p_value_equality”,
          “p_value”,
        ],
      },
    },
    “effect_size_associations”: {
      “type”: “array”,
      “items”: {
        “type”: “object”,
        “properties”: {
          “text”: {
            “type”: “string”,
            “description”: “The text of the association.”,
          },
          “rationale”: {
            “type”: “string”,
            “description”: “The rationale for identifying and extracting this association.”,
          },
          “independent_variable”: {
            “type”: “string”,
            “description”: “The independent variable/variable of interest.”,
          },
          “dependent_variable”: {
            “type”: “string”,
            “description”: “The dependent variable/outcome variable.”,
          },
          “effect_size_type”: {
            “type”: “string”,
            “description”: “The type of effect size reported in the association.”,
          },
          “effect_size_value”: {
            “type”: “number”,
            “description”: “The value of the effect size reported in the association.”,
          },
          “ci_level”: {
            “type”: “number”,
            “description”: “The confidence interval level as a decimal (e.g., 0.95), if reported.”,
          },
          “ci_lower”: {
            “type”: “number”,
            “description”: “The lower bound of the confidence interval, if reported.”,
          },
          “ci_upper”: {
            “type”: “number”,
            “description”: “The upper bound of the confidence interval, if reported.”,
          },
          “p_value_equality”: {
            “type”: “string”.
            “enum”: [“>”, “<”, “=”, “>=”, “<=”],
            “description”: “The equality used to report the value of the p-value (e.g., <, =, <=,
etc.), if reported.”,
          },
          “p_value”: {
            “type”: “number”,
            “description”: “The value of the p-value, if reported.”,
          },
        },
        “required”: [
          “text”,
          “rationale”,
          “independent_variable”,
          “dependent_variable”,
          “effect_size_type”,
          “effect_size_value”,
        ],
      },
    },
  },
  “required”: [“group_comparison_associations”, “effect_size_associations”],
}
```

For each extracted relationship (i.e., effect size or group comparison), the LLM model is prompted to provide: (1) an excerpt of text from which it is extracting the relationship and (2) a rationale for the extraction. The inclusion of a rationale is an application of Chain of Thought (CoT) prompting, aimed at increasing the LLM's reasoning capabilities as part of ongoing training;
A non-limiting example of an REx extraction process output returned by an LLM is the following:

```
{
  “effect_size_relationships”: [
    {
      “text”: “[The excerpt of the text that contains the relationship]”,
    “rationale”: “[The rationale for why the relationship was identified
and extracted as such]”,
      “variable_1”: “treatment [vs. placebo]”,
      “variable_2”: “overall survival”,
      “statistic_type”: “odds ratio”,
      “statistic_value”; 0.5,
      “ci_level”: 0.95,
      “ci_lower”: 0.4,
      “ci_upper”: 0.6,
      “p_value_equality”: “<”,
      “p_value”: 0.05
    }
  ],
  “group_comparison_relationships”: [
    {
      “text”: “[The excerpt of the text that contains the relationship]”,
    “rationale”: “[The rationale for why the relationship was identified
and extracted as such]”,
      “dependent_variable”: “survival rate”,
      “result_1”: 0.10,
      “result_2”: 0.20,
      “independent_variable_group_or_time_1”: “placebo”,
      “independent_variable_group_or_time_2”: “treatment”,
      “statistic_unit”: “%”,
      “p_value_equality”: “<”,
      “p_value”: 0.05
    }
  ]
}
```

The outputs of the relationship extraction (REx) process are input to a structured relationship process flow (as suggested by step or stage 110). Converting the extracted LLM outputs into a structured relationship allows processing each relationship based on its components. This may include checking that the outputs conform to the desired definition(s) of a relationship. This allows the filtering out of bad data and false positives, and the validation of the relationships by performing data validation on each component. In some embodiments, this may comprise:
   validating and/or cleaning elements of the extracted relationships from the output of the structured relationships process flow to ensure they meet acceptable requirements, both as individual components as well as in relation to one another. This may be done to filter out relationships that have been parsed out incorrectly or incompletely. In one non-limiting example, a validation process may include one or more of:
      checking that confidence interval bounds (when found) are valid. That is, CI lower (confidence interval lower bound) must be lower and unequal to CI upper, and the statistic value must be between the CI bounds;
      check that p value, when found, falls within the interval (0, 1) (and not including 0 or 1);
   In the case of “group comparison” relationships, the relationships may be transformed into a structured relationship by the following:
      assigning the relationship to a default statistic type of mean difference;
      consolidating the names of the two independent variable groups/times into one variable_1 name:

```
  e.g: {
    “dependent_variable”: “survival rate”,
    “result_1”: 0.10,
    “result_2”: 0.20,
    “independent_variable_group_or_time_1”: “treatment”,
    “independent_variable_group_or_time_2”: “placebo”,
    “statistic_unit”: “%”,
    “p_value_equality”: “<”,
    “p_value”: 0.05
    }
    becomes
      {
    “variable_1”: “treatment [vs. placebo]”,
    “variable_2”: “overall survival”,
    “statistic_type”: “mean difference,
    “statistic_value”: “−0.10”,
    “p_value_equality”; “<”,
    “p_value”: 0.05
}
```

Variables obtained from the output of the structured relationships process flow may then be “cleaned” and/or validated (if needed and not performed as part of the structured relationships process flow) (as suggested by step or stage 112);
   In one non-limiting example, this may comprise one or more of:
      Normalization of Unicode text to canonical ASCII equivalents, to allow for greater compatibility with downstream applications (e.g., display on web pages);
      Spelling out abbreviations used in a variable as defined in the source text. As an example: extracted variable ART from the text, which defines the abbreviation as Antiretroviral therapy (ART). The variable is corrected to Antiretroviral therapy, making the variable clearer and more informative than its original extracted form;
A semantic grounding process is then performed to more effectively clarify and/or expand the variable names or identifiers (as suggested by step or stage 114);
   As a non-limiting example, this may comprise accessing one or more comprehensive ontologies (and/or a relevant dictionary or thesaurus) to identify a similar or a generalized form of a term or concept;
After completion of the preceding steps or stages, the resulting variables, and relationships (effect size and group comparison) and associated statistical information is stored in a database for later access and evaluation (as suggested by step or stage 116);
   Such access and evaluation may include one or more of the uses disclosed and/or described in other pending and issued applications assigned to the present assignee;
      Such as, but not limited to U.S. patent application Ser. No. 17/983,180, which is a Continuation-in-Part of U.S. patent application Ser. No. 17/736,897, which is a Continuation of U.S. patent application Ser. No. 16/421,249 filed May 23, 2019, now U.S. Pat. No. 11,354,587 issued Jun. 7, 2022, which claims the benefit of priority from 62/799,981 filed Feb. 1, 2019, entitled “Systems and Methods for Organizing and Finding Data”;
   As a non-limiting example, one use case is to improve the accuracy and utility of search results provided in response to a user query by identifying results that represent content that includes effect size relations and/or group size relationships, as such sources may be expected to be more likely to be relevant to the query or provide support for the result of a search;
      In the context of the “System” architecture, the disclosed and/or described processing flow may be used to extract information and data that is then used to populate a knowledge or feature graph which may be searched by a user to identify potentially useful datasets and information, relevant results, rank results, suggest further searches, or provide other information of interest.

FIG. 1(b) is a flowchart or flow diagram illustrating a set of steps, stages, functions, operations, or processes that may be implemented in embodiment of the disclosed and/or described system and methods in which two process flows are used as part of the statistical relationship extraction process. This may be preferable to implementing the extraction process flow in a single flow or pipeline (one for both effect size and group comparison relationships) in a situation in which a user has different definitions or requirements for each type of extraction, or if they're only interested in one form of statistical relationship.

As shown in FIG. 1(b), in the example embodiment, the processing flow may include the following steps, stages, operations, or functions:
Access and initiate processing of published abstracts from a source of documents (as suggested by step or stage 120);
   In one non-limiting example, this is a PubMed server representing publications from the National Institute for Health or NIH (found at https://pubmed.ncbi.nlm.nih.gov/);
   In some embodiments, other portions of an article may be accessed and evaluated for potential relevance (such as results, conclusions, or other potentially relevant sections);
Perform sentence splitting on each of a set of the accessed abstracts (as suggested by step or stage 122);
   This can be performed with a number of techniques including rule-based sentence boundary disambiguation (SBD), or by using a transformer model trained or fine-tuned for this specific task;
Perform a model-based tagging (labeling) process for each of the sentences to isolate relevant sections of text (as suggested by step or stage 124);
This is followed by a relationship extraction process ⋅ in one embodiment, the relationship extraction process comprises two separate processing flows (referred to as PREx and GREx herein, as suggested by steps or stages 126 and 130), which individually extract either group comparison (PREx) or effect size (GREx) relationships:
   In one embodiment, the disclosed and/or described PREx process prompts an LLM to extract “paired” or group comparison relationships from an abstract of interest and place that information into a predefined string representation of a JSON object;
      As a non-limiting example of PREx extraction output (returned by the LLM as a string):

```
{
  “dependent_variable”: “survival rate”,
  “result_1”: 0.10,
  “result_2”: 0.20,
  “independent_variable_group_or_time_1”: “placebo”,
  “independent_variable_group_or_time_2”: “treatment”,
  “statistic_unit”: “%”,
  “p_value_equality”: “<”,
  “p_value”: 0.05
}
```

Using the same or a different set of abstracts, perform a pattern-based tagging (labeling) process to assign a tag or label to each abstract (as suggested by step or stage 128);
   Note that a model-based tagging process is used is for the PREx extraction process, and a pattern-based tagging process is used for the GREx extraction process;
This is followed by use of a generic or effect size relationship extraction process (referred to as GREx herein, as suggested by step or stage 130);
   In one embodiment, the disclosed and/or described GREx process prompts an LLM to extract “generic” relationships from the abstract of interest and place that information into a predefined string representation of a JSON object;
      As a non-limiting example of GREx extraction output (returned by the LLM as a string):

```
{
  “variable_1”: “treatment [vs. placebo]”,
  “variable_2”: “overall survival”,
  “statistic_type”: “odds ratio”,
  “statistic_value”: “0.5”,
  “ci_level”: 0.95,
  “ci_lower”: 0.4,
  “ci_upper”: 0.6,
  “p_value_equality”: “<”,
  “p_value”: 0.05
}
```

The outputs of the relationship extraction processes (PREx and GREx) are input to a structured relationship process flow (as suggested by step or stage 132). In one non-limiting example, this structured relationship process flow may operate as follows;
   If the two-flow relationship extraction process was used to extract effect size relationships (GREx) in a separate processing flow from group comparison relationships (PREx), then if needed, parse/load raw predictions, which are returned directly from the LLM as string representations of JSON objects, into valid JSON objects (e.g., by parsing into JSON notation). A relationship that cannot be properly parsed into a valid JSON object may be discarded to reduce the risk of relying on inaccurate extractions;
   Validate elements of the extracted relationships (from the GREx and PREx flows) to ensure that they meet acceptable requirements, both as individual components as well as in relation to one another. This may be done to filter out relationships that were parsed out incorrectly or incompletely. In one non-limiting example, this validation process may include one or more of:
      checking that confidence interval bounds (when found) are valid. That is, CI lower (confidence interval lower bound) must be lower and unequal to CI upper, and the statistic value must be between the CI bounds;
      check that p value, when found, falls within the interval (0, 1) (and not including 0 or 1);
   In the case of “group comparison” relationships, the relationships are transformed into a structured relationship by the following (where it is noted that in some embodiments, the effect size relationships extracted by either the GREx or REx process flows are extracted in the desired format):
      assigning the relationship to a default statistic type of mean difference;
      consolidating the names of the two independent variable groups/times into one variable_1 name:

```
e.g: {
  “dependent_variable”: “survival rate”
  “result_1”: 0.10,
  “result_2”: 0.20,
  “independent_variable_group_or_time_1”: “treatment”,
  “independent_variable_group_or_time_2”: “placebo”,
  “statistic_unit”: “%”,
  “p_value_equality”: “<”,
  “p_value”: 0.05
  }
  becomes
    {
  “variable_1”: “treatment [vs. placebo]”,
  “variable_2”: “overall survival”,
  “statistic_type”: “mean difference,
  “statistic_value”: “−0.10”,
  “p_value_equality”: “<”,
  “p_value”: 0.05
```

Variables obtained from the output of the structured relationships process flow are then cleaned and/or validated (if needed) (as suggested by step or stage 134);
   In one non-limiting example, this may comprise one or more of:
      Normalization of Unicode text to canonical ASCII equivalents, to allow for greater compatibility with downstream applications (e.g., display on web pages);
      Spelling out abbreviations used in a variable as defined in the source text. As an example: extracted variable ART from the text, which defines the abbreviation as Antiretroviral therapy (ART). The variable is corrected to Antiretroviral therapy, making the variable clearer and more informative than its original extracted form;
A semantic grounding process is then performed to more effectively clarify and/or expand the variable names or identifiers (as suggested by step or stage 136);
   As a non-limiting example, this may comprise accessing one or more comprehensive ontologies (and/or a relevant dictionary or thesaurus) to identify a similar or a generalized form of a term or concept;
After completion of the preceding steps or stages, the resulting variables, and relationships (effect size and group comparison) and associated statistical information is stored in a database for later access and evaluation (as suggested by step or stage 138);
   Such access and evaluation may include one or more of the uses disclosed and/or described in other pending and issued applications assigned to the present assignee;
      Such as, but not limited to U.S. patent application Ser. No. 17/983,180, which is a Continuation-in-Part of U.S. patent application Ser. No. 17/736,897, which is a Continuation of U.S. patent application Ser. No. 16/421,249 filed May 23, 2019, now U.S. Pat. No. 11,354,587 issued Jun. 7, 2022, which claims the benefit of priority from 62/799,981 filed Feb. 1, 2019, entitled “Systems and Methods for Organizing and Finding Data”;
   As a non-limiting example, one use case is to improve the accuracy and utility of search results provided in response to a user query by identifying results that represent content that includes effect size relations and/or group size relationships, as such sources may be expected to be more likely to be relevant to the query or provide support for the result of a search;
      In the context of the “System” architecture, the disclosed and/or described processing flow may be used to extract information and data that is then used to populate a knowledge or feature graph which may be searched by a user to identify potentially useful datasets and information, relevant results, rank results, suggest further searches, or provide other information of interest.

FIG. 1(c) is a block diagram illustrating a set of elements, components, functions, processes, or operations that may be part of a system architecture or data processing pipeline in which an embodiment of the disclosed and/or described system and methods may be implemented for a single process flow used as part of the statistical relationship extraction process. As shown in the figure, in one embodiment, such a system architecture or data processing pipeline may comprise the following:
A set of accessible publications, abstracts, or other information regarding studies or investigations (as suggested by PubMed FTP Server 140);
A process or service to “ingest” the publications to identify parts or sections of the publications (as suggested by Ingestion Service 142);
   In one embodiment this may comprise one or more processes such as scheduled data pipelines implemented using tools like Apache Airflow or Prefect. These pipelines can be configured to run at regular intervals (e.g., daily, weekly) to fetch new data from sources such as the PubMed FTP Server;
   For example, using Apache Airflow, a directed acyclic graph (DAG) can be defined to represent the data ingestion workflow. This DAG may include tasks such as:
      Connecting to the PubMed FTP Server using Python's ftplib library;
      Downloading new or updated publications in a structured format (e.g., XML) using the ftplib.FTP.retrbinary( ) method;
      Parsing the downloaded files to extract relevant sections or metadata using libraries like xml.etree.ElementTree for XML parsing; and
      Storing the extracted data in a database or file system for further processing;
   Similarly, using Prefect, a flow can be created to encapsulate the data ingestion process. The flow may consist of tasks similar to those described for Apache Airflow, with additional features such as automatic retries and error handling;
   These scheduled pipelines can be triggered using Python code, which can be version-controlled and maintained in a repository. The code can define the schedule (e.g., using cron expressions) and any dependencies between tasks;
   By leveraging these tools and Python's ecosystem of libraries, the data ingestion process can be automated, ensuring that the system regularly fetches and processes new publications as they become available on the PubMed FTP Server (or other source);
The ingestion service processing outputs a set of abstracts (or other identified section(s) of the accessed publications, such as the results/conclusions sections) (as suggested by PubMed Abstracts 144);
A sentence splitting process is applied to each abstract to “parse” out the sentences in the abstract (or other identified section) (as suggested by Sentence Splitting 146);
A pattern-based tagging or labeling process is then applied to each of the sentences obtained from the sentence splitting operation(s) (as suggested by Pattern-Based Tagging 148);
A relationship extraction process (Rex) is then applied (as suggested by Relationship Extraction 150);
A process to place the outputs of the extraction process into a structured form is then applied (as suggested by Structured Relationships 152);
The variables in the structured form are then validated and/or cleaned (as suggested by Variable Cleanup 154);
A semantic grounding process is then performed on the variables and/or other aspects of the structured forms (as suggested by Semantic Grounding 156); and
The resulting data, meta-data, and information are then stored in a database for subsequent access, analysis, searching, and presentation as a knowledge or feature graph (as suggested by System Database 158).

FIG. 1(d) is a block diagram illustrating a set of elements, components, functions, processes, or operations that may be part of a system architecture or data processing pipeline in which an embodiment of the disclosed and/or described system and methods may be implemented for the use of two process flows as part of the statistical relationship extraction process. As shown in the figure, in one embodiment, such a system architecture or data processing pipeline may comprise the following:
A set of accessible publications, abstracts, or other information regarding studies or investigations (as suggested by PubMed FTP Server 160);
A process or service to “ingest” the publications to identify parts or sections of the publications (as suggested by Ingestion Service 162);
   In one embodiment this may comprise one or more processes such as those disclosed and/or described with reference to Apache Airflow or Prefect;
The ingestion service processing outputs a set of abstracts (or other identified section(s) of the accessed publications, such as the results/conclusions sections) (as suggested by PubMed Abstracts 164);
A sentence splitting process is applied to each abstract to “parse” out the sentences in the abstract (or other identified section) (as suggested by Sentence Splitting 166);
A model-based tagging or labeling process may be applied to the output of the sentence splitting process (as suggested by Model-Based Tagging 170);
   A model-based approach is useful and may be necessary for the identification of text that cannot be defined reliably using rules. In particular, for spans of text describing comparisons of groups (i.e., “patients in Group A had higher rates of disease X than patients in Group B, [10% vs. 5%, p<0.05]”), a model-based approach is preferable to ensure these spans are accurately identified. This can be achieved by training or fine-tuning a model such as a transformer or recurrent neural network (RNN) for the task of text classification using examples of the relevant tags;
A pattern-based tagging or labeling process may be applied to the identified abstracts (as suggested by Pattern-Based Tagging 168);
   A pattern-based approach is applicable for relatively simple patterns that can be reliably captured using rules. In particular, for spans of text indicating statistical methods such as “odds ratio”, “pearson correlation”, etc., regular expressions can be used to reliably tag this text;
The outputs of the model-based tagging process 170 are provided as inputs to a paired or group relationship extraction process (PREx, as suggested by 172);
The outputs of the pattern-based tagging process 168 are provided as inputs to a generic or effect size relationship extraction process (GREx, as suggested by 174);
A process to place the outputs of the extraction process(es) into a structured form is then applied (as suggested by Structured Relationships 176);
The variables in the structured form(s) are then validated and/or cleaned (as suggested by Variable Cleanup 178);
A semantic grounding process is then performed on the variables and/or other aspects of the structured forms (as suggested by Semantic Grounding 180); and
The resulting data, meta-data, and information are then stored in a database for subsequent access, analysis, searching, and presentation as a knowledge or feature graph (as suggested by System Database 182).

FIG. 1(e) is a block diagram illustrating a data structure that may be used to represent statistical relationships extracted from documents, as part of an implementation of an embodiment of the disclosed and/or described system and methods. In one embodiment, the data structure comprises a relationship “row” consisting of eight components. In this example embodiment, there are four required components for writing to the disclosed system's (or platform's) database. These are variable 1, variable 2, statistic type, and statistic value.

Additionally, the data structure includes four optional components, namely p-value, confidence interval level, CI lower value, and CI upper value. These values may be used to enhance an understanding of the strength of the relationships identified and represented by the variables and related data. The structure illustrated in FIG. 1(e) accommodates a wide range of variable and statistic types, enabling representation of relationships across diverse fields and types of investigations or studies.

Encoded in this representation (as a result of identifying the variables) is a statistical relationship between the variables. For relationships measured by a directional effect size (e.g., odds ratio or hazard ratio), VARIABLE 1 represents the independent variable and VARIABLE 2 represents the dependent variable reported in the publication. For bidirectional or nondirectional effect sizes (e.g., correlation), either variable can be assigned to VARIABLE 1 or VARIABLE 2 (i.e., the assignment does not indicate a directionality).

Below is an example definition of the elements of the data structure illustrated in FIG. 1(e):
Variables (Required): Two strings representing the variables compared by the effect size statistic;
Statistic Type (Required): The type of effect size measure, e.g., odds ratio. Mapped to a set of acceptable statistic types;
Statistic Value (Required): The value of the effect size measure, e.g., 1.5. Conforms to a float representation;
Confidence Interval Level (Optional): The level of confidence, e.g., 95% or 99%. Should be able to transform this into a float representation between 0 and 1;
Confidence Interval Bounds (Optional): The confidence interval. Should be able to transform the values into float representations. The extracted lower bound must be less than the upper bound, and the statistic value must fall within this range;
P-value (Optional): The p-value used to measure the significance of the relationship between the variables. Should be able to transform this value into a float representation between 0 and 1, and this value must be accompanied by an equality or inequality.

### Identifying Candidate Documents in a Corpus for Relationship Extraction

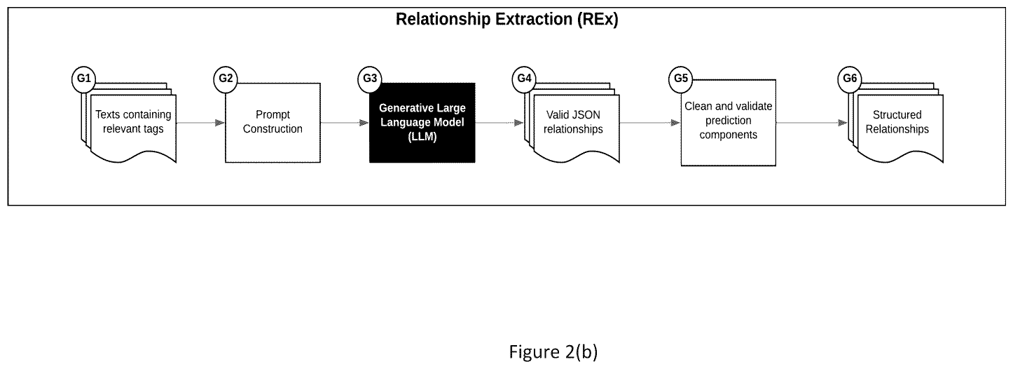

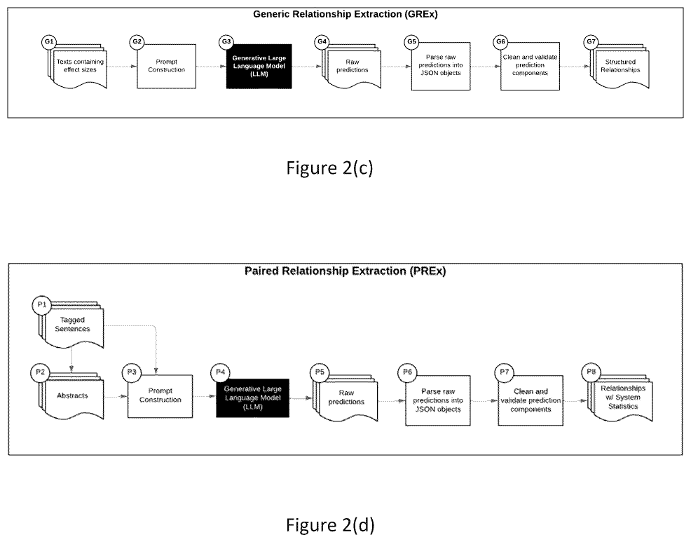

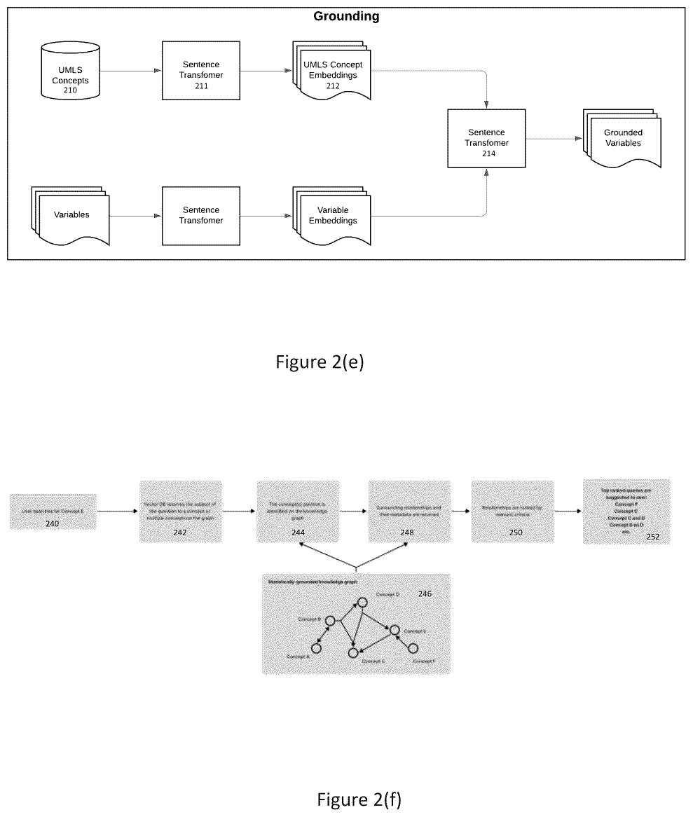

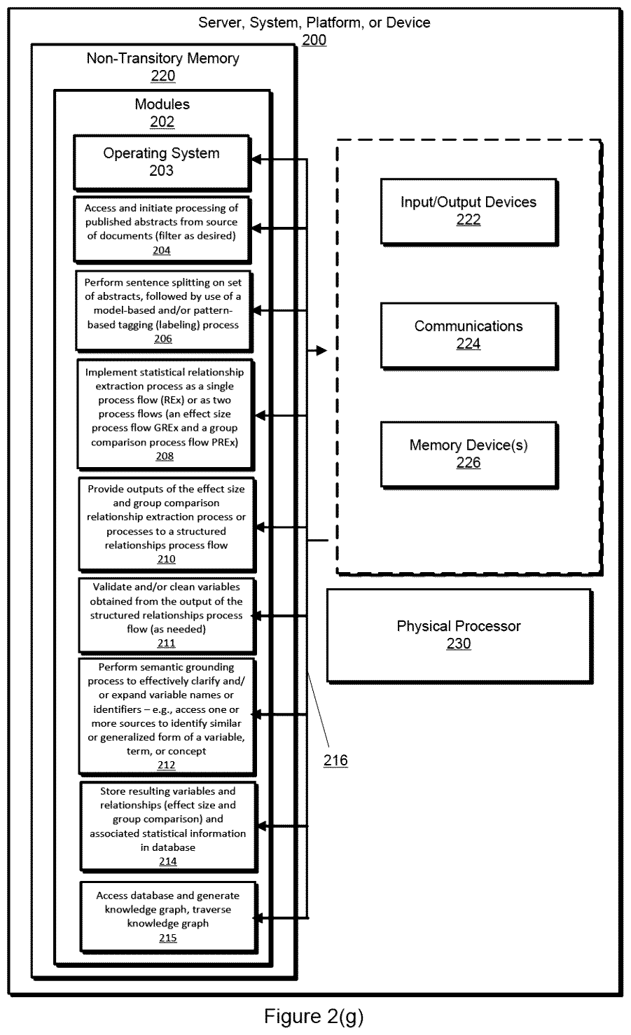

In one embodiment, a process flow to identify candidate documents for relationship extraction may comprise tagging with regular expressions and a classifier model. FIG. 2(a) is a block diagram illustrating a set of elements, components, functions, processes, or operations that may be implemented to generate tags or labels for text extracted from one or more documents as part of implementing an embodiment of the disclosed system and methods. The process flow illustrated in FIG. 2(a) may be used to narrow down or filter a set of accessed publications into a subset that is expected to be of greater value for relationship extraction.

As is recognized, large language models (LLMs) are relatively slow and expensive models to apply. Though capable of determining if input text contains statistical relationships to extract, it is inefficient and potentially costly to pass every paper in a corpus through an LLM.

To address this concern, some embodiments implement an initial (or in some cases, later) filtering process that includes a Tagging Service or function. This service or function uses patterns and/or trained models to apply tags/labels to publications that are expected to have a relatively high likelihood of containing (extractable) statistical relationships.

Tags may be assigned to specific spans of text that indicate the presence of a particular type of relationship. For example, the text “ . . . odds ratio of 1.5” indicates a statistical relationship measured by an odds ratio of 1.5, and this text may be passed into the REx or GREx pipeline. In another example, the text “ . . . (10% vs. 20%, p<0.05)” indicates a statistical relationship measured by a comparison between 2 groups, and this text may be passed into the REx or PREx pipeline.

In one embodiment, tagging patterns were identified and/or models trained with sample publications annotated by subject matter experts (as suggested by element, component, or process 202). High precision definitions/descriptions of patterns were developed to detect occurrences of between 50-100 statistic types supported by the disclosed database (i.e., as referred to by steps, stages, elements, components, or processes 116, 138, 158, and 182). Publications that contain matches to one or more of these patterns are then passed to the REx or GREx pipeline disclosed and/or described herein.

The trained model is then used as part of a Tagging Service (as suggested by element, component, or process 204). Tagging Service 204 is applied to a corpus of documents or publications, as indicated by PubMed Corpus 203 in the figure. An output of Tagging Service 204 is a set of filtered or selected documents or publications (as suggested by element, component, or process 206). For example, the filtered PubMed corpus refers to the texts in each of the pipelines that come out having relevant tags (for pattern-based) or have been classified (model-based).

In one example implementation, high-accuracy (F1˜0.9) sentence classification models were trained by fine-tuning a pre-trained language model on a dataset of annotated examples. For example, this can be achieved by fine-tuning a BERT model (Bidirectional Encoder Representations from Transformers, https://arxiv.org/abs/1810.04805). In one embodiment, annotations or labels were binary flags applied to sentences indicating whether they contained the necessary relationship information for successful extraction by the REx or PREx (and in some cases, GREx) pipelines disclosed and/or described herein.

FIG. 2(a) illustrates the workflow for both pattern and model-based tags; as described, the Tagging Service allows for relatively fast filtration of a corpus of papers to those more likely to contain relationships of interest. Pattern-based tagging allows for the identification of tokens that indicate the presence of effect size relationships (e.g., by searching for “odds ratio”), whereas model-based tagging allows for the identification of more complex spans of text that indicate the presence of group comparison relationships. This filtered corpus is then passed to the more computationally expensive LLM pipelines.

### Relationship Extraction (REx) Pipeline

FIG. 2(b) is a diagram illustrating a process flow or data processing pipeline for extracting statistical relationships from a corpus of documents in a single process flow (REx) as part of implementing an embodiment of the disclosed and/or described system and methods.

In one embodiment, the disclosed and/or described Relationship Extraction (REx) pipeline may include one or more of the following elements, components, functions, or processes, as illustrated in FIG. 2(b):
G1: The system filters for texts containing at least one of:
   Effect size measures such as odds ratios, hazard ratios, or Pearson correlations, as non-limiting examples, to identify potential statistical relationships;
   Sentences containing at least 2 numbers and 1 p-value, to identify potential group comparison associations;
G2: An LLM prompt is constructed which provides: (1) a prompt containing a task definition and instructions, one or more basic, high-level examples, (2) examples of exchanges between the “user” (an example of scientific text) and the “assistant” (the LLM's extractions for the scientific text) as representative cases of how the LLM should work, (3) a target scientific text from which the LLM should extract relationships, if any are present, and (4) a JSON schema or schemas for the desired output (i.e., function calling) to define the LLM's output structure;
G3: The constructed prompt is passed into the LLM for inference;
   This step involves feeding the generated prompt into a large language model LLM that has been trained on a vast amount of text data and fine-tuned using instruction-based learning or reinforcement learning from human feedback (RLHF);
   The LLM used for this purpose can be either a general-purpose model or a domain-specific model, depending on the nature of the task and the desired level of specialization;
G4: The LLM outputs valid JSON predictions containing potential statistical relationships from the target scientific text/publication/document;
G5: The individual components of the structured relationships are cleaned and validated in accordance with the definitions or formats defined. Components that do not pass validation may result in part or all the relationship being discarded;
G6: The resulting structured relationships are output by the pipeline and stored and/or made available to other processes.

As mentioned, in one embodiment, two separate processing pipelines may be utilized for the extraction of statistical relationships, one for group comparison (or paired) relationships and a second pipeline for extracting effect size (or generic) relationships.

### Generic Relationship Extraction (GREx) Pipeline

FIG. 2(c) is a diagram illustrating a process flow or data processing pipeline (GREx) for extracting effect size (generic) statistical relationships from a corpus of documents as part of implementing an embodiment of the disclosed and/or described system and methods.

In one embodiment, the disclosed and/or described Generic Relationship Extraction (GREx) pipeline may include one or more of the following elements, components, functions, or processes, as illustrated in FIG. 2(c):
G1: The process filters a corpus for texts containing effect size measures such as odds ratios, hazard ratios, or Pearson correlations, as non-limiting examples, to identify publications that potentially include statistical relationships;
G2: An LLM prompt is constructed which: 1) defines a structured relationship in a JSON schema, 2) provides examples of scientific texts and the relationships extracted from them, and 3) provides a target scientific text from which the LLM should extract relationships, if any are present;
G3: The constructed prompt is passed into the LLM for inference;
   This step involves feeding the generated prompt into a large language model LLM that has been trained on a vast amount of text data and fine-tuned using instruction-based learning or reinforcement learning from human feedback (RLHF);
   The LLM used for this purpose can be either a general-purpose model or a domain-specific model, depending on the nature of the task and the desired level of specialization;
G4: The LLM outputs raw text predictions containing potential statistical relationships from the target scientific text/publication/document;
G5: Raw predictions, comprising one or more JSON strings representing structured relationships, are parsed into valid JSON objects;
G6: The individual components of the structured relationships are cleaned and validated according to the definitions defined herein. Components that do not pass validation may result in part or all the relationship being discarded;
G7: The resulting structured relationships are output by the pipeline and stored and/or made available to other processes.

### Paired Relationships (PREx) Pipeline

FIG. 2(d) is a diagram illustrating a process flow or data processing pipeline (PREx) for extracting group comparison (paired) statistical relationships from a corpus of documents as part of implementing an embodiment of the disclosed and/or described system and methods.

Group Comparison or Paired Relationship Extraction enables identification and capture of relationships that are defined by two, rather than one, statistical value. This is applicable in cases where two groups or time periods (as examples) are compared directly to each other by the authors of a publication. In such situations, the disclosed and/or described system extracts pairs of numbers whose association is explicitly measured in significance by a single p-value.

In one embodiment, the disclosed and/or described Paired Relationship Extraction (PREx) pipeline may include one or more of the following elements, components, functions, or processes, as illustrated in FIG. 2(d):
P1: Sentences identified by a sentence classifier (e.g., see the process description herein for Identifying Candidate Documents) as containing at least 2 numbers and 1 p-value are classified as positive for containing a relationship of the form expected, and that were classified with a (confidence) score above a chosen threshold;
P2: Abstracts from which the P1 sentences were extracted;
P3: Positively classified sentences are combined with their original abstracts as well as one or more prompt questions to generate one prompt per publication or set of text;
   Construct a prompt to be input to a Large Language Model (LLM)—as a non-limiting example:
Prompt: Ask the model to identify relationships comparing two groups/times and to return information about those relationships in a strict JSON structure;
   For pairs of numbers comparing results between groups or a change in results over time and that are linked by a p-value, fill out the following JSON schema:

{
“dependent_variable”: _{——}_{_{—}},
“result_1”: _{——}_{_{—}},
“result_2”: _{——}_{_{—}},
“independent_variable_group_or_time_1”: _{——}_{_{—}},
“independent_variable_group_or_time_2”: _{——}_{_{—}},
“statistic_unit”: _{——}_{_{—}},
“p_value_equality”: _{——}_{_{—}},
“p_value”: _{——}_{_{—}},
}

Use a chained question to ask the model to validate its own answer to the previous question/prompt;
For each JSON object, check that the JSON is true to the source text. Correct any inaccuracies and return the full JSONs. If none are valid, return “None”.
P4: Prompt is passed into LLM;
   This step involves feeding the generated prompt into a large language model LLM that has been trained on a vast amount of text data and fine-tuned using instruction-based learning or reinforcement learning from human feedback (RLHF);
   The LLM used for this purpose can be either a general-purpose model or a domain-specific model, depending on the nature of the task and the desired level of specialization;
P5: LLM outputs raw predictions;
P6: Parsing-load JSON objects from strings that get returned as predictions from the LLM (which may implement a form of GPT). Can return more than one JSON prediction per prompt/publication;
P7: Validation—the prediction components are validated for their required values (or range or other characteristic) as well as for the required form or structure of those values;
   This may include postprocessing, such as filtering/cleaning malformed strings, going back to the abstract contents to make corrections as far as this process stage can be automated;
P8: Calculate the difference between the numbers in each result pair and store them in a database as mean differences;
   In some embodiments, this may comprise converting an extracted relationship (such as an example of a relationship extracted using the PREx process flow) into a standard format.

While relationship extraction does not necessarily involve supervised training of an LLM, in some embodiments, the disclosed and/or described approach may perform ongoing analyses on random samples of a large number (e.g., thousands) of studies to ensure that the models used are able to extract relationships and other information accurately. In this regard, the models employed by the assignee consistently achieved 87-90% end-to-end accuracy on the task of relationship extraction.

### Grounding Variables in a Scientific Ontology

In one embodiment, the Unified Medical Language System (UMLS) was selected as the ontology of choice, due to its interoperability with dozens of scientific and general ontologies and knowledge bases. The ontology chosen may be other than the UMLS and will depend upon the area(s) of study described in the publications and the terms and concepts used in that area or areas. Regardless of the ontology chosen, the grounding of variables may be performed in the same or an equivalent manner to that disclosed and/or described herein.

FIG. 2(e) is a diagram illustrating a process flow or data processing pipeline for “grounding” identified variables using one or more ontologies as part of implementing an embodiment of the disclosed and/or described system and methods.

### UMLS Search Index

In one embodiment, a search index is constructed using concepts from UMLS, along with their definitions and aliases (as suggested by steps, stages, elements, components, or processes 210). This data is transformed into numerical representations, known as embeddings (212), using a pretrained transformer model specifically designed for biomedical literature (as suggested by 211). Examples of such transformer models include but are not limited to BioGPT as well as various BioBERT, BlueBERT, and PubMedBERT models.

### Linking Variables to UMLS Concepts

Variables are similarly transformed into embeddings using the same model and process. These variables are linked to UMLS concepts through semantic similarity, utilizing a pretrained transformer model specialized for biomedical literature (214). The disclosed and/or described assignee's System architecture, platform, and processes for performing statistical search and other forms of data organization may be used to construct and traverse a UMLS knowledge graph to connect with other scientific ontologies, such as Medical Subject Headings (MeSH), SNOMED-CT, and less specific sources such as Wikidata, thereby enhancing the understanding and application of statistical relationships in research and practice. The lower branch of the process flow illustrated in FIG. 2(e) represents the same or similar process flow as applied to the variables in the extracted relationships.

### Risk Mitigation

LLMs (specifically generative models) have been found to produce inaccurate results in certain scenarios (termed “hallucinations”), which can be problematic for applications that rely on high-quality information. To mitigate this risk, embodiments may incorporate one or more of the following safeguards:
1. Upfront filtering: use of a Tagging Service to filter out portions of the PubMed corpus that are unlikely to contain the information desired for extraction. This helps to limit the risk of LLMs returning answers based on insufficient information;
2. Prompt engineering: use of a structured approach to prompting a generative model, providing examples and hints from an abstract, and asking the model not to answer if unsure. Can also incorporate follow-up validation within the same prompt to improve accuracy;
3. Strict validation of generative model outputs: validation of the outputs of a generative model to check for text matches for numbers, and grounding variables with human-curated taxonomies/ontologies;
4. Postprocessing of extracted relationships: handling errors in extraction with rules-based logic (this may also or instead use follow-up prompting in some cases). Follow-up prompting is driven by ongoing quality checks, which provide insight into certain types or categories of publications that may require specific care.

An example of a situation of possible LLM errors is with diagnostic studies, where statistics are often used to compare two diagnostic methods or tools, rather than to compare a treatment and outcome. In this category, the disclosed and/or described models may benefit from specific follow-up prompting to minimize the risk of error. Variable names and duplicated variables may be improved to increase interoperability and improve downstream applications.

The approach disclosed and/or described herein was developed by System Inc. (www.system.com), a Public Benefit Corporation dedicated to creating a platform that enables users to see, analyze, and use connections between various aspects of available information and data. As non-limiting examples, this may include the impact of treatments or risk factors on health outcomes, or the influence of socioeconomic status on overall well-being.

In the context of an embodiment of the disclosed and/or described system or platform, a statistical relationship serves as a fundamental building block of information and knowledge. This disclosure is directed to a technique that plays a role in facilitating the extraction and representation of these relationships at scale, thereby empowering users to explore and better comprehend the connections and relationships present in published studies and investigations. These relationships can be utilized in various applications, such as meta-analyses, systematic reviews, and knowledge discovery, as non-limiting examples.

In contrast, existing approaches for extracting statistical relationships from scientific literature are limited in scope and performance. For instance, the INDRA (Integrated Network and Dynamical Reasoning Assembler, https://www.indra.bio/) focuses on a specific domain with a significant amount of human-curated data sources, while other approaches primarily concentrate on semantic relation extraction rather than extracting statistical relationships. Further, current research on general causal relationship extraction has not reached performance levels believed necessary for reliable application to real world tasks.

Embodiments of the disclosure provide several advantages over existing solutions, including the elimination of the need for training data for semantic relation extraction and the requirement of a relatively small amount of training data for transformer training. Additionally, the structured output generated by one or more embodiments allows for the data to be displayed and synthesized more effectively, and thereby provide a more comprehensive understanding of the extracted relationships and the systems of which they are a part. By addressing and overcoming the limitations of existing solutions, embodiments significantly enhance the efficiency and accuracy of extracting statistical relationships from scientific literature, enabling new applications and insights in both research and practice.

The following is a non-limiting example of the application of an embodiment of the disclosed system and methods and is based on the abstract below:

### Title: The Effect of a Novel Treatment on the Incidence of Disease X: A Randomized Controlled Trial

Abstract: Background: Disease X is a significant public health concern, affecting millions of individuals worldwide. This study aimed to investigate the efficacy of a novel treatment (Treatment A) in reducing the incidence of Disease X compared to a placebo. Methods: A randomized controlled trial was conducted, including 500 participants aged 18-65 years, who were randomly assigned to receive either Treatment A (n=250) or a placebo (n=250). The primary outcome was the incidence of Disease X after 12 months of treatment. Results: The incidence of Disease X was significantly lower in the Treatment A group compared to the placebo group (odds ratio [OR]=0.65, 95% confidence interval [CI]=0.45-0.93, p=0.02). Conclusion: Treatment A demonstrated a significant reduction in the incidence of Disease X compared to the placebo, suggesting its potential as an effective intervention for Disease X prevention.

Using this example, the following describes an implementation of one or more of the steps of the disclosed and/or described approach:

### Tagging

The system identifies the PubMed abstract as a candidate text containing a potential statistical relationship, specifically an odds ratio: (odds ratio [OR]=0.65, 95% confidence interval [CI]=0.45-0.93, p=0.02).

### Prompt Construction

A prompt is constructed for the LLM to extract the relationship between Treatment A and the incidence of Disease X, as well as the odds ratio, confidence interval, and p-value.

Prompt: Provide Multiple Examples of Abstracts Along with the Statistical Relationships we would Extract from them, then Provide the Abstract in Question for Inference.
Extract all Statistical Relationships from the Following PubMed Abstracts into this JSON Schema:

[{“independent_variable”: str, “dependent_variable”: str, “statistic_type”: str, “statistic_value”:
float, “ci_level”: float | null, “ci_lower”: float | null, “ci_upper”: float | null, “p_value”: float | null,
“p_value_equality”: str | null}]

### Rules:

Spell out any abbreviated terms.
Report statistics verbatim, exactly as they are mentioned in the text.

Abstract: Background: Disease X is a significant public health concern . . .

### Relationships:

### LLM Inference

The LLM processes the prompt and generates a raw text prediction containing the statistical relationship:

{“variable_1”: “Treatment A”, “variable_2”: “incidence of Disease X”, “statistic_type”: “odds
ratio”, “statistic_value”: 0.65, “ci_level”: 0.95, “ci_lower”: 0.45, “ci_upper”: 0.93,
“p_value_equality”: “<”, “p_value”: 0.02}

Parsing: The raw text prediction is parsed into a valid JSON object representing the structured relationship between Treatment A and the incidence of Disease X;
Validation: The individual components of the structured relationship are cleaned and validated, ensuring that the odds ratio, confidence interval, and p-value conform to a required format and values;
Grounding: The variables “Treatment A” and “incidence of Disease X” are linked to relevant concepts from the UMLS, such as specific treatment names and disease identifiers;
Downstream applications: The extracted relationship can now be utilized for various applications, such as meta-analyses, systematic reviews, and research network visualization, thereby providing valuable insights into the efficacy of Treatment A in reducing the incidence of Disease X.

As another non-limiting example, FIG. 2(f) is a diagram illustrating a use of the disclosed and/or described statistical relationship extraction process flow(s) as part of populating a feature or knowledge graph of the type enabled by the assignee, and then using that feature or knowledge graph to execute a search to identify concepts and related data or metadata for that search. This may suggest other searches or modified searches that could be of interest to a user.

Search is a focused task that begins with knowing what to look for. Suggested queries may be presented to a user to help them find additional information (e.g., more detailed, or simply tangential) believed to be of possible interest. Conventional search engines accomplish this by tracking searches across all users, then mining these records to determine additional searches that may be relevant to the current user's search based on historical logs of other users. These solutions are based on history and the prevalence of other user actions, and not on a systemic or scientific understanding of related concepts to contextualize a user's current query.

Instead, it is proposed to leverage a knowledge or feature graph of statistically grounded relationships (as disclosed and/or described in one or more issued patents and/or pending applications assigned to the assignee of the present disclosure) to identify concepts related to the user's query and to identify a context for the user's search.

As a non-limiting example, this may be done using the graph architecture disclosed and/or described in one or more of the assignee's issued patents and/or pending applications to identify statistically related concepts to recommend to a user. This method of recommendation is made possible because of the disclosed and/or described graph architecture and associated functions for identifying, extracting, encoding, and storing statistical relationships.

As shown in FIG. 2(f), in one embodiment, a user enters a query or search for a concept E (as suggested by step or stage 240). The user's query is semantically resolved to a known concept(s) or relationship(s) between multiple concepts on the knowledge/feature graph using a vector database (as suggested by step or stage 242). The “position” of the desired concept is identified on the knowledge/feature graph (as suggested by step or stage 244). An example of a section of the knowledge/feature graph that might be retrieved or identified in response to the search or query is shown as element 246 in the figure.

Next, the surrounding or “local” relationships to the searched for concept (E) (and any relevant metadata) are identified by traversing the graph and are returned (step or stage 248) and ranked according to one or more criteria or rules (step or stage 250), before presentation to the user (step or stage 252).

Note that in one non-limiting example, one or more recommended searches may be a result of learning the interests of a user and providing them with recommendations following the same recommendation logic.

To determine which queries are suggested to a user, the concepts and concept relationships can be ranked by one or more criteria (as suggested by step or stage 250 in the figure) prior to presentation to the user:
Ranking based on relationship components: Direction can be used to filter suggestions and surface pathways. For example, if a user searches for the relationship of Concept D on Concept E, suggestions can be constrained to concepts or relationships upstream of Concept D and downstream of Concept E;
Additionally, suggestions can be boosted based upon the informational depth of a given concept or relationship to ensure suggestions being made are either well-established, or when users needed it, to showcase a lack of depth (and thus an opportunity to fill a data void). As non-limiting examples:
   Quality or quantity of the evidence substantiating the relationship in the graph;
   Based on the most unexpectedly statistically related;
   Based on identifying the higher order “neighborhoods” of the related concepts and recommending concepts from diverse “neighborhoods” (e.g., a statistically related environmental concept is recommended to a user searching for a health topic);
Ranking based on metadata: Other possible criteria for ranking includes extracted metadata for the underlying statistical evidence, such as boosting suggestions based on recency of the underlying evidence, strength of the relationship, sign of the relationship, and relevancy based upon nature of the relationship (i.e., is the evidence studying a biological factor or sociological? Which is more relevant to the user's query?). Journal and author metadata can also be used to boost relationships based on user preferences; and
Ranking based on search logs: Suggestions can also be ranked based on previous user engagement as well as popularity among other users.

Although multiple embodiments and implementations of the disclosure have been described and illustrated, further extensions or variations are possible and are part of this disclosure. For extensions or variations to be successful, it is important to tailor the selection of model(s) and training data to the specific domain and task at hand, to select models with sufficient bias and non-linearity to adequately capture real patterns in the space/domain, and to ensure that the desired task is one that can be learned (i.e., one that is not entirely stochastic by nature). As non-limiting examples, extensions of the disclosed and/or described process flows, concepts, use cases, and implementations may include one or more of:

### Variations on Implementation:

Using different definitions of a statistical relationship and its components;
Using different algorithms and models for one or more steps of the processing pipeline(s);
Grounding using other ontologies;
Extracting relationship components individually, then connecting them together, instead of doing it in a single step; or
Use of a fine-tuned model with 10s to 100s of thousands of human-labeled annotations.
Other example uses enabled by an embodiment of the disclosed approach:
Applications in other domains, such as law and/or finance;
   The disclosed and/or described approach may be applied to domains outside of the life sciences. These applications would benefit from the use of specialized ontologies for grounding variables in those fields. The approach to defining and extracting statistical relationships would remain substantially the same, and minor adjustments to the LLM prompts (e.g. providing domain-specific examples) can be used to tailor the application to the domain of interest;
Generalization to extract high-precision structured information (such as mechanistic or causal relationships) from unstructured text;
In this regard, the disclosure provides an extendable pattern for extracting structured information from text:
   Defining a structured and testable model for data, as with relationships;
   Employ a combination of instruction and example-based LLM prompting to extract information from unstructured text;
   Use of programmatic tools to validate the structured data; or
   Ground components of the structured data in an ontology or knowledge base that is suited to the specific domain.

FIG. 2(g) is a diagram illustrating elements, components, or processes that may be present in or executed by one or more of a computing device, server, platform, or system configured to implement a method, process, function, or operation in accordance with some embodiments of the disclosed and/or described systems and methods. In some embodiments, the disclosed and/or described system and methods may be implemented in the form of an apparatus or apparatuses (such as a server that is part of a system or platform, or a client device) that includes a processing element and a set of executable instructions. The executable instructions may be part of a software application (or applications) and arranged into a software architecture.

In general, an embodiment of the disclosure may be implemented using a set of software instructions that are executed by a suitably programmed processing element (such as a GPU, TPU, CPU, microprocessor, processor, controller, or other form of computing device). In a complex application or system such instructions are typically arranged into “modules” with each such module typically performing a specific task, process, function, or operation. The set of modules may be controlled or coordinated in their operation by an operating system (OS) or other form of organizational platform.

A module and/or sub-module may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

As shown in FIG. 2(g), system 200 may represent one or more of a server, client device, platform, or other form of computing or data processing device. Modules 202 each contain a set of executable instructions, where when the set of instructions is executed by a suitable electronic processor (such as that indicated in the figure by “Physical Processor(s) 230”), system (or server, platform, or device) 200 operates to perform a specific process, operation, function, or method (or multiple ones).

Modules 202 may contain one or more sets of instructions for performing a method, operation, process, or function disclosed herein and/or described with reference to the Figures and the descriptions provided in the specification. The modules may include those illustrated but may also include a greater number or fewer number than those illustrated. Further, the modules and the set of computer-executable instructions contained in the modules may be executed (in whole or in part) by the same processor or by more than a single processor. If executed by more than a single processor, the processors may be contained in different devices, for example a processor in a client device and a processor in a server that is part of a platform.

Modules 202 are stored in a (non-transitory) memory 220, which typically includes an Operating System module 203 that contains instructions used (among other functions) to access and control the execution of the instructions contained in other modules. The modules 202 in memory 220 are accessed for purposes of transferring data and executing instructions by use of a “bus” or communications line 216, which also serves to permit processor(s) 230 to communicate with the modules for purposes of accessing and executing instructions. Bus or communications line 216 also permits processor(s) 230 to interact with other elements of system 200, such as input or output devices 222, communications elements 224 for exchanging data and information with devices external to system 200, and additional memory devices 226.

Each module or sub-module may contain a set of computer-executable instructions that when executed by a programmed processor or processors cause the processor or processors (or a device, devices, server, or servers in which they are contained) to perform a specific function, method, process, or operation.

As mentioned, an apparatus in which a processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed and/or described system and methods, such as to:
Access and initiate processing of published abstracts from a source of documents (as suggested by module 204);
   In one non-limiting example, this is a PubMed server representing publications from the NIH (found at https://pubmed.ncbi.nlm.nih.gov/);
   In one embodiment, this may include implementing a form of filtering or selection of the accessed abstracts (or other portions of a publication) to identify those most likely to contain statistical relationships;
Perform sentence splitting on a set of the abstracts (as suggested by module 206);
   This is followed by use of one or more of a model-based tagging (labeling) process and/or a pattern-based tagging process that functions to identify and label effect size relationships (e.g., “odds ratio”, “OR=1.5”, “pearson r=0.5”) and group comparison associations (e.g., “patients in Group A had higher rates of disease X than patients in Group B, [10% vs. 5%, p<0.05]”);
      The model-based tagging process is used to identify/extract group comparison relationships as part of the REx or PREx flows;
      The pattern-based tagging process is used to identify/extract effect size relationships as part of the REx or GREx flows;
This is followed by execution of a statistical relationship extraction process (as suggested by module 208);
   In one embodiment, the extraction process is implemented as a single process flow or pipeline (referred to as REx herein);
   In another embodiment, the extraction process is implemented as two separate process flows or pipelines, one for extraction of group comparison relationships (referred to as PREx herein) and a second for extraction of effect size relationships (referred to as GREx herein);
Provide the outputs of the relationship extraction process (the REx) or processes (the PREx and GREx) to a structured relationships process flow (as suggested by module 210);
   The structured relationship process flow functions to place the extracted data into a standardized and more uniform structure which is better adapted for further processing and evaluation;
Validate and/or clean variables obtained from the output of the structured relationships process flow (as needed) (as suggested by module 211);
Perform a semantic grounding process to effectively clarify and/or expand variable names or identifiers (as suggested by module 212);
   As a non-limiting example, this may comprise accessing one or more comprehensive ontologies, dictionaries, or thesauri (as examples) to identify a similar or a generalized form of a variable, term, or concept;
After completion of the preceding steps or stages, the resulting variables and relationships (group comparison and effect size) and associated statistical information is stored in a database for later access and evaluation (as suggested by module 214);
At a later time, the database is accessed and used to generate a knowledge or feature graph (or a portion of one) and enable a user to traverse the knowledge graph to identify information, data, metadata, relationships, research, or databases expected to be relevant in responding to a user search or query (as suggested by module 215);
   As mentioned herein, the System platform described in U.S. patent application Ser. No. 16/421,249, entitled “Systems and Methods for Organizing and Finding Data, now issued U.S. Pat. No. 11,354,587 discloses and describes the construction and use of a knowledge or feature graph to assist in identifying and accessing information that is expected to be of value because of the statistical relationships described in a study or investigation.

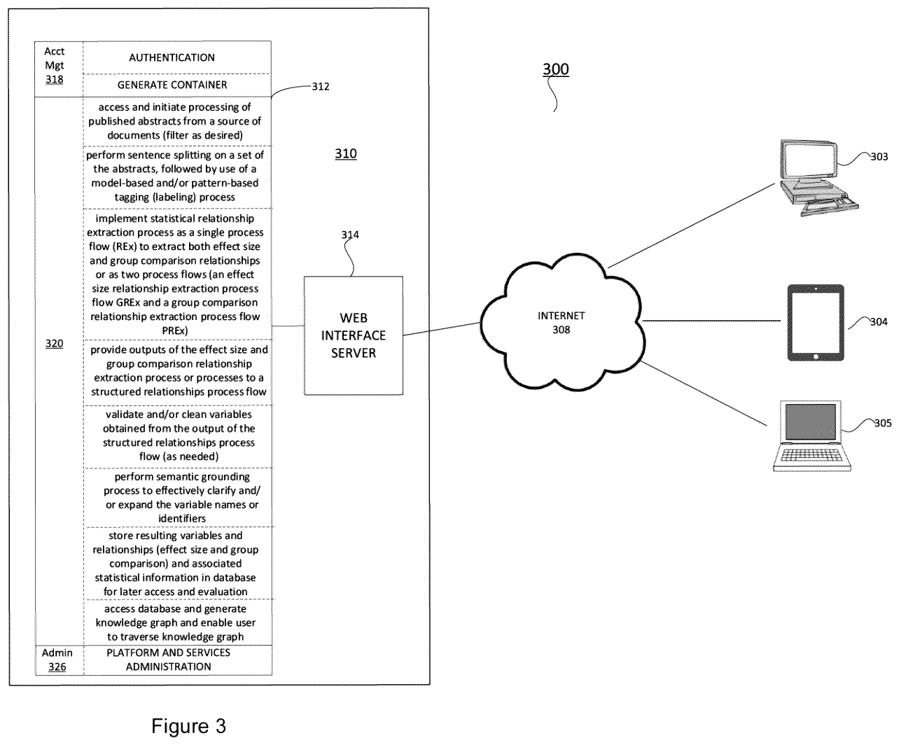

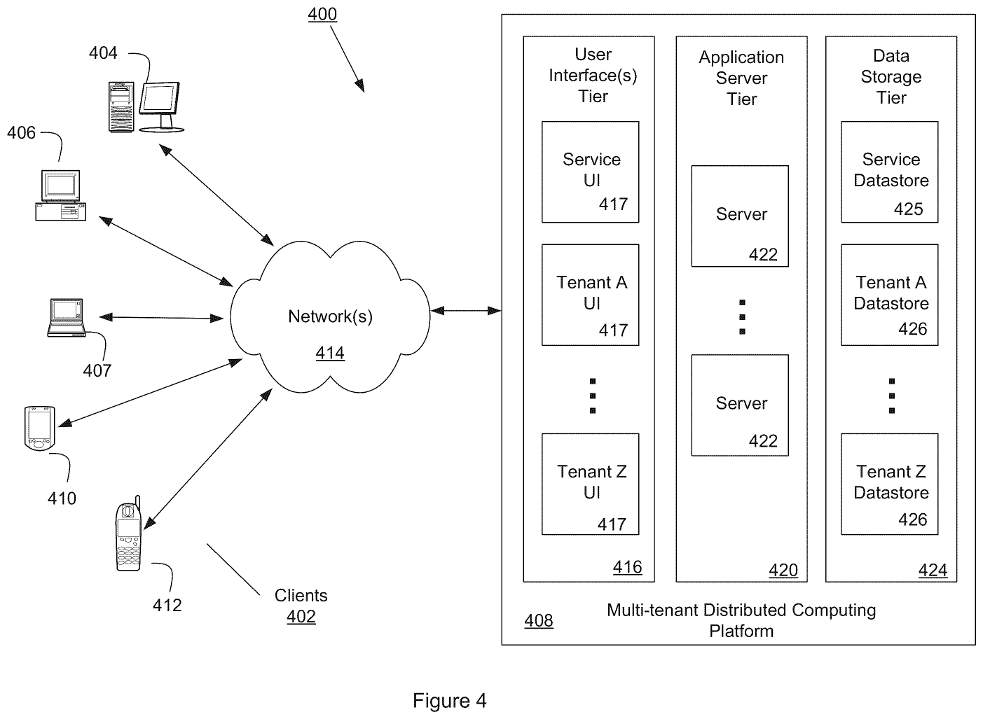

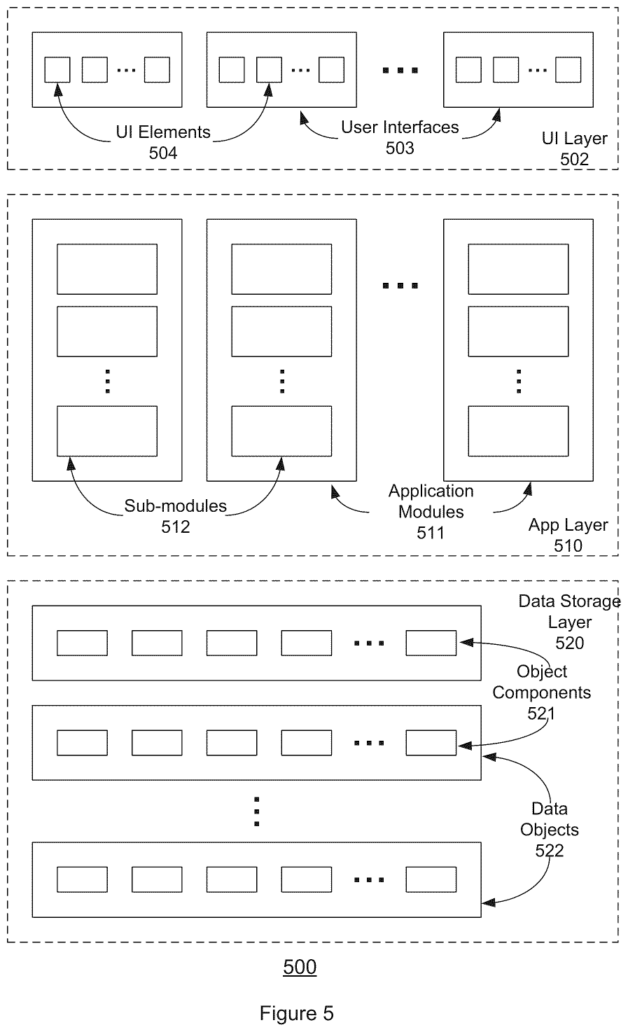

In some embodiments, the functionality and services provided by the systems and methods disclosed and/or described herein may be made available to multiple users by accessing an account maintained by a server or service platform. Such a server or service platform may be termed a form of Software-as-a-Service (Saas). FIG. 3 is a diagram illustrating a SaaS system with which an embodiment may be implemented. FIG. 4 is a diagram illustrating elements or components of an example operating environment with which an embodiment may be implemented. FIG. 5 is a diagram illustrating additional details of the elements or components of the multi-tenant distributed computing service platform of FIG. 4, with which an embodiment may be implemented.

In some embodiments, the system or services disclosed and/or described herein may be implemented as micro-services, processes, workflows, or functions performed in response to the submission of a user's responses. The micro-services, processes, workflows, or functions may be performed by a server, data processing element, platform, or system. In some embodiments, the data analysis and other services may be provided by a service platform located “in the cloud”. In such embodiments, the platform may be accessible through APIs and SDKs. The functions, processes and capabilities described herein may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. Although in some embodiments, a platform or system of the type illustrated in FIGS. 3-5 may be operated by a 3rd party provider to provide a specific set of business-related applications, in other embodiments, the platform may be operated by a provider and a different business may provide the applications or services for users through the platform.

FIG. 3 is a diagram illustrating a system 300 with which an embodiment may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, or organizations. A user may access the services using a suitable client, including but not limited to desktop computers 303, laptop computers 305, tablet computers, scanners, or smartphones 304. A user interfaces with the service platform across the Internet 308 or another suitable communications network or combination of networks.

Platform 310, which may be hosted by a third party, may include a set of services to assist a user to access the data processing and relationship extraction services disclosed and/or described herein 312, and a web interface server 314, coupled as shown in FIG. 3. Either or both the services 312 and the web interface server 314 may be implemented on one or more different hardware systems and components, even though represented as singular units in FIG. 3.

Services 312 may include one or more functions, processes, or operations for enabling a user to access a set of sources, filter those sources, and extract one or both of effect size and group comparison statistical relationships from the sources. This may be followed by construction of a knowledge or feature graph for traversal by a user to identify potentially useful data, metadata, information, datasets, or other aspects of a source or corpus of sources.

As examples, in some embodiments, the set of functions, operations, processes, or services made available through platform 310 may include:
Account Management services 318, such as
   a process or service to authenticate a user (in conjunction with submission of a user's credentials using the client device);
   a process or service to generate a container or instantiation of the services or applications that will be made available to the user;
services for accessing and processing documents 320, such as
   a process or service to access and initiate processing of published abstracts from a source of documents (with filtering as desired);
   a process or service to perform sentence splitting on a set of the abstracts;
      this is followed by use of a model-based and/or pattern-based tagging (labeling) process;
   a process or service to implement a statistical relationship extraction process as a single process flow (REx) to extract both effect size and group comparison relationships or as two process flows (an effect size relationship extraction process flow GREx and a group comparison relationship extraction process flow PREx);
   a process or service to provide outputs of the effect size and group comparison relationship extraction process or processes to a structured relationships process flow;
   a process or service to validate and/or clean variables obtained from the output of the structured relationships process flow (as needed);
   a process or service to perform a semantic grounding process to effectively clarify and/or expand the variable names or identifiers;
      this may comprise accessing one or more comprehensive ontologies, dictionaries, or thesauri to identify similar or a generalized form of a variable, term, or concept;
   a process or service to store the resulting variables and relationships (effect size and group comparison) and associated statistical information in a database for later access and evaluation;
      this may include metadata, a link to a relevant database, or other information or data relevant to a source or document;
   a process or service to access the database and generate a knowledge or feature graph and enable a user to traverse the knowledge graph to identify information, data, relationships, metadata, research, or databases expected to be relevant in responding to a user search or query; and
Administrative services 326, such as
   a process or services to enable the provider of the services and/or the platform to administer and configure the processes and services provided to users;
      this may include modifying a process flow, an authentication process, a format of data output by a process, a rule or criteria used for filtering a set of sources, or enable or modify other relevant process, function, or operation.

The platform or system shown in FIG. 3 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server.

FIG. 4 is a diagram illustrating elements or components of an example operating environment 400 in which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (i.e., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (or an administrator of the platform, and depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow are provided to users, with each business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, with which an embodiment may be implemented. In general, an embodiment of the invention may be implemented using a set of software instructions that are designed to be executed by a suitably programmed processing element (such as a CPU, GPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, with which an embodiment may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as a variety of controls, parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user of the platform). Such function, method, process, or operation may include those used to implement one or more aspects of the disclosed and/or described systems and methods, such as to:
access and initiate processing of published abstracts from a source of documents (filter as desired);
perform sentence splitting on a set of the abstracts;
   this is followed by use of a model-based and/or pattern-based tagging (labeling) process;
implement a statistical relationship extraction process as a single process flow (REx) to extract both effect size and group comparison relationships or as two process flows (an effect size relationship extraction process flow GREx and a group comparison relationship extraction process flow PREx);
provide outputs of the effect size and group comparison relationship extraction process or processes to a structured relationships process flow;
validate and/or clean variables obtained from the output of the structured relationships process flow (as needed);
perform a semantic grounding process to effectively clarify and/or expand the variable names or identifiers;
   this may comprise accessing one or more comprehensive ontologies, dictionaries, or thesauri to identify similar or a generalized form of a variable, term, or concept;
store the resulting variables and relationships (effect size and group comparison) and associated statistical information in a database for later access and evaluation;
   this may include metadata, a link to a relevant database, or other information or data relevant to a source or document; and
access the database and generate a knowledge or feature graph and enable a user to traverse the knowledge graph to identify information, data, relationships, metadata, research, or databases expected to be relevant in responding to a user search or query.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:
1. A method for extracting information from a document, comprising:
accessing a published abstract of a document;
performing a sentence splitting operation on the accessed abstract;
applying one or more of a model-based tagging process or a pattern-based tagging to the sentences determined by the sentence splitting operation to identify one or more sections of text relevant to the content of the abstract or document;
executing a statistical relationship extraction process on the determined sentences to extract effect size relationships and group comparison relationships from the abstract;
providing outputs of the statistical relationship extraction process as inputs to a structured relationships process flow, the structured relationships process flow filtering and validating the outputs of the statistical relationship extraction process;
performing a semantic grounding process on the outputs of the structured relationships process flow to clarify or expand the variable names in the outputs;
storing the variable names resulting from the semantic grounding process, extracted statistical relationships, and associated statistical information in a database;
receiving a user query representing a search desired by the user, the query including a topic of interest to the user;
accessing the database and executing the search over the stored variable names, extracted statistical relationships, and associated statistical information; and
forming a graph from the results of executing the search, the graph including a set of nodes and a set of edges, wherein each edge in the set of edges connects a node in the set of nodes to one or more other nodes, and further, wherein each node represents one of the topic of interest, a variable found to be statistically associated with the topic of interest, or a topic found to be statistically or semantically associated with the topic of interest, and each edge represents a statistical association between a node and the topic of interest or between a first node and a second node.
2. The method of clause 1, further comprising:
traversing the graph formed from the results of executing the search;
identifying a dataset or datasets associated with one or more variables that are statistically associated with the topic of interest or are statistically associated with a topic semantically related to the topic of interest; and
presenting the results of the graph traversal and identification of the dataset or datasets to the user.
3. The method of clause 1, wherein a plurality of published abstracts with each abstract corresponding to a document are accessed and processed.
4. The method of clause 3, wherein the plurality of published abstracts are accessed from a server hosting multiple scientific or research articles.
5. The method of clause 1, wherein the semantic grounding process is performed using one or more ontologies.
6. The method of clause 5, wherein the one or more ontologies include the Unified Medical Language System.
7. The method of claim 1, further comprising performing one or more of the steps of the method on the document associated with the abstract.
8. The method of claim 1, wherein storing the variable names resulting from the semantic grounding process, extracted statistical relationships, and associated statistical information in a database further comprises storing metadata associated with the variable names, extracted statistical relationships, or associated statistical information.
9. The method of clause 1, wherein the statistical relationship extraction process extracts the effect size relationships and group comparison relationships together in a single process and outputs a JSON object, or wherein the statistical relationship extraction process extracts each of the effect size relationships and the group comparison relationships in a separate process flow.
10. A system, comprising:
one or more electronic processors configured to execute a set of computer-executable instructions; and
one or more non-transitory electronic data storage media containing the set of computer-executable instructions, wherein when executed, the instructions cause the one or more electronic processors to
   access a published abstract of a document;
   perform a sentence splitting operation on the accessed abstract;
   apply one or more of a model-based tagging process or a pattern-based tagging to the sentences determined by the sentence splitting operation to identify one or more sections of text relevant to the content of the abstract or document;
   execute a statistical relationship extraction process on the determined sentences to extract effect size relationships and group comparison relationships from the abstract or the document;
   provide outputs of the statistical relationship extraction process as inputs to a structured relationships process flow, the structured relationships process flow filtering and validating the outputs of the statistical relationship extraction process;
   perform a semantic grounding process on the outputs of the structured relationships process flow to clarify or expand the variable names in the outputs;
   store the variable names resulting from the semantic grounding process, extracted statistical relationships, and associated statistical information in a database;
   receive a user query representing a search desired by the user, the query including a topic of interest to the user;
   access the database and executing the search over the stored variable names, extracted statistical relationships, and associated statistical information; and
   form a graph from the results of executing the search, the graph including a set of nodes and a set of edges, wherein each edge in the set of edges connects a node in the set of nodes to one or more other nodes, and further, wherein each node represents one of the topic of interest, a variable found to be statistically associated with the topic of interest, or a topic found to be statistically or semantically associated with the topic of interest, and each edge represents a statistical association between a node and the topic of interest or between a first node and a second node.
11. The system of clause 10, wherein the instructions further cause the one or more electronic processors to:
traverse the graph formed from the results of executing the search;
identify a dataset or datasets associated with one or more variables that are statistically associated with the topic of interest or are statistically associated with a topic semantically related to the topic of interest; and
present the results of the graph traversal and identification of the dataset or datasets to the user.
12. One or more non-transitory computer-readable media comprising a set of computer-executable instructions that when executed by one or more programmed electronic processors, cause the processors to
access a published abstract of a document;
perform a sentence splitting operation on the accessed abstract;
apply one or more of a model-based tagging process or a pattern-based tagging to the sentences determined by the sentence splitting operation to identify one or more sections of text relevant to the content of the abstract or document;
execute a statistical relationship extraction process on the determined sentences to extract effect size relationships and group comparison relationships from the abstract or the document;
provide outputs of the statistical relationship extraction process as inputs to a structured relationships process flow, the structured relationships process flow filtering and validating the outputs of the statistical relationship extraction process;
perform a semantic grounding process on the outputs of the structured relationships process flow to clarify or expand the variable names in the outputs;
store the variable names resulting from the semantic grounding process, extracted statistical relationships, and associated statistical information in a database;
receive a user query representing a search desired by the user, the query including a topic of interest to the user;
access the database and executing the search over the stored variable names, extracted statistical relationships, and associated statistical information; and
form a graph from the results of executing the search, the graph including a set of nodes and a set of edges, wherein each edge in the set of edges connects a node in the set of nodes to one or more other nodes, and further, wherein each node represents one of the topic of interest, a variable found to be statistically associated with the topic of interest, or a topic found to be statistically or semantically associated with the topic of interest, and each edge represents a statistical association between a node and the topic of interest or between a first node and a second node.
13. The one or more non-transitory computer-readable media of clause 16, wherein the instructions further cause the one or more electronic processors to:
traverse the graph formed from the results of executing the search;
identify a dataset or datasets associated with one or more variables that are statistically associated with the topic of interest or are statistically associated with a topic semantically related to the topic of interest; and
present the results of the graph traversal and identification of the dataset or datasets to the user.

The disclosed system and methods can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. A trained neural network, trained machine learning model, or any other form of decision or classification process may be used to implement one or more of the methods, functions, processes, or operations disclosed and/or described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. In terms of a computational model, each neuron calculates the dot product of inputs and weights, adds the bias, and applies a non-linear trigger or activation function (for example, using a sigmoid response function).

The software components, processes, or functions disclosed and/or described in this application may be implemented as software code to be executed by a processor using a suitable computer language such as Python, Java, JavaScript, C, C++, or Perl using conventional or object-oriented techniques. The software code may be stored as a series of instructions or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. Such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or forms of memories based on similar technologies. Such computer-readable storage media allow the processing element or processor to access computer-executable process steps and application programs, stored on removable and non-removable memory media, to off-load data from a device or to upload data to a device. As mentioned, with regards to the embodiments disclosed and/or described herein, a non-transitory computer-readable medium may include a structure, technology, or method apart from a transitory waveform or similar medium.

Example embodiments of the disclosure are described herein with reference to block diagrams of systems, and/or flowcharts or flow diagrams of functions, operations, processes, or methods. One or more blocks of the block diagrams, or one or more stages or steps of the flowcharts or flow diagrams, and combinations of blocks in the block diagrams and combinations of stages or steps of the flowcharts or flow diagrams may be implemented by computer-executable program instructions. In some embodiments, one or more of the blocks, or stages or steps may not necessarily need to be performed in the order presented or may not necessarily need to be performed at all.

The computer-executable program instructions may be loaded onto a general-purpose computer, a special purpose computer, a processor, or other programmable data processing apparatus to produce a specific example of a machine. The instructions that are executed by the computer, processor, or other programmable data processing apparatus create means for implementing one or more of the functions, operations, processes, or methods disclosed and/or described herein. The computer program instructions may be stored in (or on) a computer-readable memory that may direct a computer or other programmable data processing apparatus to function in a specific manner, such that the instructions stored in (or on) the computer-readable memory produce an article of manufacture including instruction means that when executed implement one or more of the functions, operations, processes, or methods disclosed and/or described herein.

While embodiments of the disclosure have been described in connection with what is presently considered to be the most practical approach and technology, the embodiments are not limited to the disclosed implementations. Instead, the disclosed implementations are intended to include and cover modifications and equivalent arrangements included within the scope of the appended claims. Although specific terms are employed herein, they are used in a generic and descriptive sense only and not for purposes of limitation.

This written description uses examples to describe one or more embodiments of the disclosure, and to enable a person skilled in the art to practice the disclosed approach and technology, including making and using devices or systems and performing the associated methods. The patentable scope of the disclosure is defined by the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference was individually and specifically indicated to be incorporated by reference and/or was set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Method steps or stages disclosed and/or described herein may be performed in any suitable order unless otherwise indicated herein or clearly contradicted by context.

The use of examples or exemplary language (e.g., “such as”) herein, is intended to illustrate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer items in the alternative and in combination.

Different arrangements of the elements, structures, components, or steps illustrated in the figures or described herein, as well as components and steps not shown or described are possible. Similarly, some features and sub-combinations are useful and may be employed without reference to other features and sub-combinations. Embodiments have been described for illustrative and not for restrictive purposes, and alternative embodiments may become apparent to readers of the specification. Accordingly, the disclosure is not limited to the embodiments described in the specification or depicted in the figures, and modifications may be made without departing from the scope of the appended claims.

That which is claimed is:

1. A method for extracting information from a document, comprising:
accessing a published abstract of a document;
performing a sentence splitting operation on the accessed abstract;
applying one or more of a model-based tagging process or a pattern-based tagging to the sentences determined by the sentence splitting operation to identify one or more sections of text relevant to the content of the abstract or document;
executing a statistical relationship extraction process on the determined sentences to extract effect size relationships and group comparison relationships from the abstract or the document;
providing outputs of the statistical relationship extraction process as inputs to a structured relationships process flow, the structured relationships process flow filtering and validating the outputs of the statistical relationship extraction process;
performing a semantic grounding process on the outputs of the structured relationships process flow to clarify or expand the variable names in the outputs;
storing the variable names resulting from the semantic grounding process, extracted statistical relationships, and associated statistical information in a database;
receiving a user query representing a search desired by the user, the query including a topic of interest to the user;
accessing the database and executing the search over the stored variable names, extracted statistical relationships, and associated statistical information; and
forming a graph from the results of executing the search, the graph including a set of nodes and a set of edges, wherein each edge in the set of edges connects a node in the set of nodes to one or more other nodes, and further, wherein each node represents one of the topic of interest, a variable found to be statistically associated with the topic of interest, or a topic found to be statistically or semantically associated with the topic of interest, and each edge represents a statistical association between a node and the topic of interest or between a first node and a second node.

2. The method of claim 1, further comprising:
traversing the graph formed from the results of executing the search;
identifying a dataset or datasets associated with one or more variables that are statistically associated with the topic of interest or are statistically associated with a topic semantically related to the topic of interest; and
presenting the results of the graph traversal and identification of the dataset or datasets to the user.

3. The method of claim 1, wherein a plurality of published abstracts with each abstract corresponding to a document are accessed and processed.

4. The method of claim 3, wherein the plurality of published abstracts are accessed from a server hosting multiple scientific or research articles.

5. The method of claim 1, wherein the semantic grounding process is performed using one or more ontologies.

6. The method of claim 5, wherein the one or more ontologies include the Unified Medical Language System.

7. The method of claim 1, further comprising performing one or more of the steps of the method on the document associated with the abstract.

8. The method of claim 1, wherein storing the variable names resulting from the semantic grounding process, extracted statistical relationships, and associated statistical information in a database further comprises storing metadata associated with the variable names, extracted statistical relationships, or associated statistical information.

9. The method of claim 1, wherein the statistical relationship extraction process extracts the effect size relationships and group comparison relationships together in a single process and outputs a JSON object, or wherein the statistical relationship extraction process extracts each of the effect size relationships and the group comparison relationships in a separate process flow.

10. A system, comprising:
one or more electronic processors configured to execute a set of computer-executable instructions; and
one or more non-transitory electronic data storage media containing the set of computer-executable instructions, wherein when executed, the instructions cause the one or more electronic processors to
access a published abstract of a document;
perform a sentence splitting operation on the accessed abstract;
apply one or more of a model-based tagging process or a pattern-based tagging to the sentences determined by the sentence splitting operation to identify one or more sections of text relevant to the content of the abstract or document;
execute a statistical relationship extraction process on the determined sentences to extract effect size relationships and group comparison relationships from the abstract or the document;
provide outputs of the statistical relationship extraction process as inputs to a structured relationships process flow, the structured relationships process flow filtering and validating the outputs of the statistical relationship extraction process;
perform a semantic grounding process on the outputs of the structured relationships process flow to clarify or expand the variable names in the outputs;
store the variable names resulting from the semantic grounding process, extracted statistical relationships, and associated statistical information in a database;
receive a user query representing a search desired by the user, the query including a topic of interest to the user;
access the database and executing the search over the stored variable names, extracted statistical relationships, and associated statistical information; and
form a graph from the results of executing the search, the graph including a set of nodes and a set of edges, wherein each edge in the set of edges connects a node in the set of nodes to one or more other nodes, and further, wherein each node represents one of the topic of interest, a variable found to be statistically associated with the topic of interest, or a topic found to be statistically or semantically associated with the topic of interest, and each edge represents a statistical association between a node and the topic of interest or between a first node and a second node.

11. The system of claim 10, wherein the instructions further cause the one or more electronic processors to:
traverse the graph formed from the results of executing the search;
identify a dataset or datasets associated with one or more variables that are statistically associated with the topic of interest or are statistically associated with a topic semantically related to the topic of interest; and
present the results of the graph traversal and identification of the dataset or datasets to the user.

12. The system of claim 10, wherein a plurality of published abstracts with each abstract corresponding to a document are accessed and processed.

13. The system of claim 10, wherein the semantic grounding process is performed using one or more ontologies.

14. The system of claim 10, wherein the instructions further cause the one or more electronic processors to perform one or more of the executed steps on the document associated with the abstract.

15. The system of claim 10, wherein the statistical relationship extraction process extracts the effect size relationships and group comparison relationships together in a single process and outputs a JSON object, or wherein the statistical relationship extraction process extracts each of the effect size relationships and the group comparison relationships in a separate process flow.

16. One or more non-transitory computer-readable media comprising a set of computer-executable instructions that when executed by one or more programmed electronic processors, cause the processors to
access a published abstract of a document;
perform a sentence splitting operation on the accessed abstract;
apply one or more of a model-based tagging process or a pattern-based tagging to the sentences determined by the sentence splitting operation to identify one or more sections of text relevant to the content of the abstract or document;
execute a statistical relationship extraction process on the determined sentences to extract effect size relationships and group comparison relationships from the abstract or the document;
provide outputs of the statistical relationship extraction process as inputs to a structured relationships process flow, the structured relationships process flow filtering and validating the outputs of the statistical relationship extraction process;
perform a semantic grounding process on the outputs of the structured relationships process flow to clarify or expand the variable names in the outputs;
store the variable names resulting from the semantic grounding process, extracted statistical relationships, and associated statistical information in a database;
receive a user query representing a search desired by the user, the query including a topic of interest to the user;
access the database and executing the search over the stored variable names, extracted statistical relationships, and associated statistical information; and
form a graph from the results of executing the search, the graph including a set of nodes and a set of edges, wherein each edge in the set of edges connects a node in the set of nodes to one or more other nodes, and further, wherein each node represents one of the topic of interest, a variable found to be statistically associated with the topic of interest, or a topic found to be statistically or semantically associated with the topic of interest, and each edge represents a statistical association between a node and the topic of interest or between a first node and a second node.

17. The one or more non-transitory computer-readable media of claim 16, wherein the instructions further cause the one or more electronic processors to:
traverse the graph formed from the results of executing the search;
identify a dataset or datasets associated with one or more variables that are statistically associated with the topic of interest or are statistically associated with a topic semantically related to the topic of interest; and
present the results of the graph traversal and identification of the dataset or datasets to the user.

18. The one or more non-transitory computer-readable media of claim 16, wherein a plurality of published abstracts with each abstract corresponding to a document are accessed and processed.

19. The one or more non-transitory computer-readable media of claim 16, wherein the semantic grounding process is performed using one or more ontologies.

20. The one or more non-transitory computer-readable media of claim 16, wherein the instructions further cause the one or more electronic processors to perform one or more of the executed steps on the document associated with the abstract.
